(19) United States
(12) Patent Application Publication
(10) Pub. No.: US 2007/0026120 A1
(43) Pub. Date: Feb. 1, 2007

(54) Flavored fruit segments and methods of making the same

(75) Inventors: Mathew O. Wight, Malaga, WA (US); Michael J. Young, East Wenatchee, WA (US)

Correspondence Address: SEED INTELLECTUAL PROPERTY LAW GROUP PLLC, 701 FIFTH AVE, SUITE 5400, SEATTLE, WA, 98104, US

(73) Assignee: Stemilt Growers, Inc., Wenatchee, WA (US)

(21) Appl. No.: 11/477,132

(22) Filed: Jun. 27, 2006

Related U.S. Application Data
(60) Provisional application No. 60/694,595, filed on Jun. 27, 2005.

(51) Int. Cl. A23L 1/22

(52) U.S. Cl. 426/535

(57) ABSTRACT

Compositions, methods, and kits for flavoring raw, cut or uncut fruit segments or fruit are provided. Also provided are an automated system, business methods, and a process for manufacturing raw, cut or uncut, flavored fruit segments or fruit.

### CROSS-REFERENCE TO RELATED APPLICATIONS

This application claims benefit under 35 USC 119(e) of U.S. Provisional Application No. 60/694,595, filed on Jun. 27, 2005, which is incorporated herein by reference in its entirety.

### BACKGROUND OF THE INVENTION

1. Field of the Invention

The present invention relates generally to raw, cut or uncut, flavored fruit segments or fruit and methods of making the same. Particular embodiments of the present invention are described herein.

2. Description of the Related Art

Fresh or raw, uncooked fruit is universally recognized as a nutritional food for a meal or snack. Fresh or raw fruit is high in vitamins and fiber, and low in calories. In addition, the sweetness of fresh fruit is due to fructose, which increases body blood sugar levels at a slower rate than does processed sugar. Finally, consumers want food products that are appealing, and can be eaten with a minimum amount of preparation. In the past, various methods of cooking or canning fruit produced such food products, but these processes diminish the fruit's nutritional value as well as texture and taste. Therefore, due to the importance of providing consumers with fresh fruit that tastes good and is ready-to-eat, it would be desirable to have a wider variety of flavored fresh fruit segments available for human consumption. The present invention fills this void and provides other related advantages.

### DETAILED DESCRIPTION OF THE INVENTION

Definitions

For the purposes of the present invention, the terms and phrases used herein, shall have their plain and ordinary meaning as appreciated by one of skill in the art. In particular instances, we define the following terms to be defined as set forth herein.

“Clean,” “Step of Cleaning,” “Cleaned,” and any and all other derivations, refers to removing excess dirt, dust, chemical residues or other foreign material from said fruit, wherein “foreign material” may be derived from plant, animal or other source.

“Anti-browning agent,” and any and all derivations, refers to an agent that preserves, protects, retains, or promotes the flavor, color, texture, cell wall structure, appearance, crispness, moisture, or other desirable characteristic of raw fruit.

“Raw” fruit, and any and all derivations, refers to any variety of fruit or combination of fruits which may be whole or cut, pitted, cored, stoned and/or peeled, which have not undergone cooking, or heating above about 90-120° F., but the term “raw” may include fruit that has been coated, filled, contacted with at least one flavoring, sweetened, contacted with at least one anti-browning agent, and/or packaged.

“Cores,” and any and all derivations, refers to removing the central inedible part of a fruit, and shall include removing seeds, pits, stones, or other inedible parts.

“Organic,” and any and all derivations, refers to products whose source has been certified organic by the U.S. Department of Agriculture. (See www.usda.org.)

Embodiments of the present invention relate to a composition comprising raw, cut or uncut, flavored fruit segments or fruit, wherein said segments comprise cut, raw fruit and one or more flavoring agents. The present invention includes raw or fresh cut fruit, wherein the cut fruit is not a sauce or paste, but instead is in the form of a segment. The raw, cut or uncut, flavored fruit is uncooked and thus, maintains its nutritional integrity. In particular the macro-nutrients (protein, carbohydrate and fat levels), as well as the micro-nutrients (vitamins, minerals, etc.) of the raw, cut or uncut, flavored fruit segments or fruit, are relatively unchanged from the uncut fruit's original nutritional content. The presently claimed invention may use fruit that is peeled or unpeeled, for all embodiments herein described. The one or more flavoring agent(s) described herein may be natural, artificial and/or organic.

Further embodiments of the invention relate to kits and methods of making raw, cut or uncut, flavored fruit segments or fruit, wherein the fruit segments or fruit are not in the form of a sauce or paste. Such kits and methods are set out in further detail herein.

The present invention further relates to compositions of raw, cut, flavored fruit segments produced by any of the methods disclosed herein, wherein the raw, cut, flavored fruit segments are not in the form of a sauce or paste.

The present invention relates to any fruit capable of being flavored. In particular embodiments of the present invention, the fruit may include apples, pears, Asian pears, cherries, strawberries, plums, peaches, nectarines, grapes, melons (including watermelon, cantaloupe, honey dew melon, muskmelon, etc.), guava, dates, figs, apricots, kiwi, citrus fruit (including lemons, limes, grapefruit, oranges, tangelos, kumquats, ugli fruit, mandarin oranges, Satsuma oranges, etc.), mango, bananas, passion fruit, pineapple, cranberries, blueberries, blackberries, papaya, coconut, jackfruit, or others. One of skill in the art would recognize that any variety of fruit, including any variety of apples, pears, Asian pears, cherries, or any other fruit could be used to practice the presently claimed invention.

In particular, varieties of apples that may be used to practice the claimed invention include, but are not limited to: Red Delicious, Golden Delicious, Gala, Fuji, Rome, Ginger Gold, Granny Smith, Braeburn, Cameo, Pink Lady, Jonagold, Rome Beauty, Wealthy, Stayman, Jonathan, Mcintosh, Cortland, Akane, Jonamac, Nittany, Vista Bella, Elstar, Royal Gala, Winter Banana, or any combination of these or any other varieties. Particular varieties of pears that may be used to practice the claimed invention include, but are not limited to: European or Asian pears, Bartlett, Red Bartlett, Taylor's Gold™, Concorde™, Seckel, Red Anjou, Green Anjou, Bosc, Comice, Forelle, D'Anjou, Clairgeau, Easter Beurre, Flemish Beauty, Kieffer, Pound, Sheldon, Winter Nelis, P. Barry, or any combination of these or any other varieties. Particular varieties of cherries that may be used to practice the claimed invention include, but are not limited to: Bing, Black Tartarian, Brook, Tulare, Garnet, Chelan, Lapin, Sonata, Hill Bing, Hill Lambert, Hill Lapin, Sweetheart, Skeena, Staccato, Schmidt, Chapman, Republican, Lambert, Ranier, Regina, Sandra Rose, Van, Sonata, Black Gold, Early Robin, Attika, and any combination thereof.

One of skill in the art would recognize that the present invention may be practiced with fruit that is cultivated, organic, genetically modified, hybrid cross, or wild cultivars.

Quality Control

The present invention also relates to a method for assessing fruit for quality to enhance subsequent flavoring, comprising evaluating fruit based on one or more fruit grade assessments selected from the group consisting of: measuring sugar content or testing soluble solids; measuring whole fruit size; measuring starch content; measuring fruit firmness or pressure; testing fruit acidity; assessing fruit color; assessing seed color; assessing fruit taste; assessing fruit texture and assessing fruit aroma. In certain embodiments, the fruit is sorted for storage or is sorted and flavored and then stored.

One particular exemplary embodiment of the present invention relates to raw, cut or uncut, flavored fruit segments or flavored fruit, wherein the fruit is an apple. In the exemplary embodiment wherein the fruit is an apple, the fruit used to practice the presently claimed invention may have a United States Department of Agriculture federal grade selected from the group consisting of: U.S. Fancy, U.S. Extra Fancy and any combination thereof. Alternatively, the fruit used to practice the presently claimed invention may have any federal grade available, including any grade level utilized internationally.

Accordingly, this disclosure includes the U.S. Standards for Grades of Apples, §§ 51.300-51.321 of the Agricultural Marketing Act, as amended (7 U.S.C. 1624), are hereby incorporated by reference in its entirety. Several specific standards for apple grades are disclosed herein, as well as in Tables 1 and 2.

As used herein, the federal food grade of fruit refers to the criteria established by the U.S. Department of Agriculture. In particular, “U.S. Extra Fancy” includes apples of one variety (except where more than one variety is printed on the container) which are mature but not overripe, clean, fairly well formed and relatively free from decay, internal browning, internal breakdown, soft scald, scab, freezing injury, visible water core, and broken skins. “U.S. Extra Fancy” apples are also relatively free from injury caused by bruises, brown surface discoloration, smooth net-like russeting, sunburn or sprayburn, limb rubs, hail, drought spots, scars, disease, insects, or other means. “U.S. Extra Fancy” apples are relatively free from damage caused by bitter pit or Jonathan spot and by smooth solid, slightly rough or rough russeting, or stem or calyx cracks, as well as damage by invisible water core after January 31^{st} of the year following the year of production except for Fuji variety of apples.

As used herein, “U.S. Fancy” apples include apples of one variety (except when more than one variety is printed on the container) which are relatively mature but not overripe, clean, fairly well formed, and relatively free from decay, internal browning, internal breakdown, soft scald, freezing injury, visible water core, and broken skins. “U.S. Fancy” apples are also relatively free from damage caused by bruises, brown surface discoloration, russeting, sunburn or sprayburn, limb rubs, hail, drought spots, scars, stem or calyx cracks, disease, insects, bitter pit, Jonathan spot, or damage by other means, or invisible water core after January 31^{st} of the year following the year of production, except for Fuji variety of apples.

As used herein, “U.S. No. 1” includes apples which meet the requirements of “U.S. Fancy” grade except for certain characteristics, such as color, russeting, and invisible water core. “U.S. No. 1” apples are relatively free from excessive damage caused by russeting. That is, the apples meet the russeting requirements for “U.S. Fancy,” except the aggregate area of an apple which may be covered by smooth net-like russeting usually does not exceed 25%; and the aggregate area of an apple which may be covered by smooth solid russeting usually does not exceed 10%, except that in the case of the Yellow Newtown or similar varieties, the aggregate area of an apple which may be covered with smooth solid russeting usually does not exceed 20%. Invisible water core is generally not scored in this grade.

As used herein, “U.S. No. 1 Hail” includes apples that meet the requirements of U.S. No. 1 grade except that hail marks where the skin has not been broken and well-healed hail marks where the skin has been broken, are permitted, provided the apples are fairly well formed.

As used herein, “U.S. Utility” includes apples of one variety (except when more than one variety is printed on the container) that are relatively mature but not overripe, not seriously deformed and relatively free from decay, internal browning, internal breakdown, soft scald, and freezing injury. “U.S. Utility” apples are also relatively free from serious damage caused by dirt or other foreign matter, broken skins, bruises, brown surface discoloration, russeting, sunburn or sprayburn, limb rubs, hail, drought spots, scars, stem or calyx cracks, visible water core, bitter pit or Jonathan spot, disease, insects or other means.

In addition to these typical characteristics, apple varieties of the grades disclosed herein also typically have the color specified in Table 1. Apple varieties other than those listed in Table 1 have no color requirements pertaining to these grades.

TABLE 1

| The apple | | | |
|---|---|---|---|
| varieties listed | | | |
| below have color | | | |
| requirements | U.S. Extra Fancy | U.S. Fancy | U.S. No. 1 |
| VARIETY | PERCENT | PERCENT | PERCENT |
| Red Delicious | 66 | 40 | 25 |
| Red Rome | 66 | 40 | 25 |
| Empire | 66 | 40 | 25 |
| Idared | 66 | 40 | 25 |
| Winesap | 66 | 40 | 25 |
| Jonathan | 66 | 40 | 25 |
| Stayman | 50 | 33 | 25 |
| Mclntosh | 50 | 33 | 25 |
| Cortland | 50 | 33 | 25 |
| Rome Beauty | 50 | 33 | 25 |
| Delicious | 50 | 33 | 25 |
| York | 50 | 33 | 25 |

As used in Table 1, the color requirements for the solid red varieties indicate the percentage of the area of the surface, which should be covered with a good shade of solid red characteristic of the variety. However, an apple having color of a lighter shade of solid red or striped red than that considered as a good shade of red characteristic of the variety may be admitted to a grade, if it has sufficient additional area covered so that the apple has as good an appearance as one with the minimum percentage of good red characteristic of the variety required for the grade. For the striped red varieties, the percentage stated refers to the area of the surface in which the stripes of a good shade of red characteristic of the variety typically predominates over stripes of lighter red, green or yellow. However, an apple having color of a lighter shade than that considered as a good shade of red characteristic of the variety may be admitted to a grade, provided it has sufficient additional area covered so that the apple has as good appearance as one with the minimum percentage of stripes of a good red characteristic of the variety required for the grade.

Color standards U.S. Dept. of Agriculture Visual Aid APL-CC-1 (Plates a-e), hereby incorporated by reference in their entireties, illustrate minimum good shade of solid red or striped red color, minimum compensating color and shade not considered color, for the following varieties: Red Delicious, Red Rome, Empire, Idared, Winesap, Jonathan, Stayman, Mcintosh, Cortland, Rome Beauty, Delicious and York.

When size is designated by the numerical count for a container, typically not more than 10% of packages in the lot may fail to be fairly uniform. As used herein, “fairly uniform” may indicate that the size of the fruit within the container does not vary more than ½ inch diameter from the smallest to largest fruit, and that any particular apple may be slightly abnormal in shape but not to an extent which detracts materially from its appearance.

When size is designated by minimum or maximum diameter, generally not more than 5% of the apples in any lot may be smaller than the designated minimum, and generally not more than 10% may be larger than the designated maximum. For Red Delicious or Golden Delicious varieties, a combination of minimum diameter and/or weight may be used.

Any decay, scald, or other deterioration which may have developed on apples after they have been in storage or transit is generally considered as affecting the condition of the apples, and not the grade.

Generally, as used in the U.S.D.A. guidelines and herein, “mature,” refers to apples that have reached the stage of development which will insure the proper completion of the ripening process. Before a mature apple becomes overripe, it will show varying degrees of firmness, depending on the stage of the ripening process.

In addition to the term, “mature,” apples may be referred to by the following U.S.D.A. descriptions: “hard,” generally refers to apples with a tenacious flesh and starchy flavor; “firm,” generally refers to apples with a tenacious flesh but which are becoming crisp with a slightly starchy flavor, except the Delicious variety; “firm ripe,” generally refers to apples with crisp flesh except that the flesh of the Gano, Bed Davis, and Rome Beauty varieties may be slightly mealy; “ripe,” generally refers to apples with mealy flesh and soon to become soft for the variety; and “overripe,” generally refers to apples which have progressed beyond the stage of ripe, with flesh very mealy or soft, and past commercial utility.

In addition to these U.S.D.A. standard grades for fresh apples, the present disclosure also includes the U.S.D.A. standards for grades of frozen apples (§§ 52.361-52.371 of the Agricultural Marketing Act, as amended), dried apples (§§ 52.2481-52.2490 of the Agricultural Marketing Act, as amended), dehydrated (low moisture) apples (§§ 52.2341-52.2352 of the Agricultural Marketing Act, as amended) and canned apples (§§ 52.2161-52.2173 of the Agricultural Marketing Act, as amended), all of which are hereby incorporated by reference in their entireties.

In any of the particular embodiments set forth herein, the fruit used to practice the presently claimed invention has a Washington state grade selected from the group consisting of: Washington Extra Fancy, Washington Fancy, Washington C grade and any combination thereof. Alternatively, the fruit used to practice the presently claimed invention has any state grade available. As used herein, the Washington state apple grades specified refer to the standard grades set forth by the Washington State Department of Agriculture, Chapter 16-403 WAC, which is hereby incorporated by reference in its entirety. Except where noted, the Washington State apple term definitions parallel the U.S.D.A. definitions, and such definitions may be used interchangeably herein.

As used herein, “Washington Extra Fancy” apples include apples of one variety which are relatively mature but not overripe, carefully hand picked, clean, fairly well formed, relatively free from decay, internal browning, internal breakdown, scald, scab, bitter pit, Jonathan spot, freezing injury, visible watercore, and broken skins and bruises except those which are slight and incident to proper handling and packing. “Washington Extra Fancy” apples are also relatively free from injury caused by smooth net-like russeting, sunburn or spray-burn, limb rubs, hail, drought spots, scars, disease, insects or other means; and relatively free from damage by smooth solid, slightly rough or rough russeting, or stem or calyx cracks and free from damage by invisible watercore after January 31^{st} of the year following the year of production, provided that the invisible watercore is not be a quality factor of Fuji variety at any time.

As used herein, “Washington Fancy” apples refer to apples of one variety which are mature but not overripe, carefully hand-picked, clean, fairly well-formed; relatively free from decay, internal browning, internal breakdown, bitter pit, Jonathan spot, scald, freezing injury, visible watercore, and broken skins and bruises, except those which are incident to proper handling and packing. “Washington Fancy” apples are also relatively free from damage caused by russeting, sunburn or sprayburn, limb rubs, hail, drought spots, scars, stem or calyx cracks, disease, insects, invisible watercore after January 31^{st} of the year following the year of production, or damage by other means, provided that invisible watercore is not a quality factor of Fuji variety at any time.

As used herein, “Washington C grade” includes the same requirements for “Washington Fancy” except for color, russeting and invisible watercore. “Washington C grade” apples are relatively free from excessive damage caused by russeting with the aggregate area of an apple covered by smooth net-like russeting typically will not exceed 25%, except that with the Yellow Newtown, Granny Smith or similar varieties, the aggregate area of an apple which may be covered with smooth solid russeting typically will not exceed 20%; and the aggregate area of an apple which may be covered with excessively rough or barklike russeting or limb rubs will generally not exceed the area of a circle three-fourths of an inch in diameter.

Color requirements for all Washington State grades listed are described in Tables 2 and 3. For the solid red varieties listed in Table 2, the percentage stated refers to the area of the surface which must be covered with a good shade of solid red characteristic of the variety. However, an apple having color of a lighter shade of solid red or striped red than that considered as a good shade of red characteristic of the variety may be admitted to a grade provided it has sufficient additional area covered so that the apple has as good an appearance as one with the minimum percentage of good red characteristic of the variety required for the grade.

TABLE 2

| | EXTRA FANCY | FANCY |
|---|---|---|
| SOLID RED VARIETY | PERCENT | PERCENT |
| Black Ben | 50-66 | 33-40 |
| Gano | 50-66 | 33-40 |
| Winesap | 50-66 | 33-40 |
| Other similar varieties | 50-66 | 33-40 |
| Red sport varieties | 66 | 33-40 |

For the striped or partial red varieties listed in Table 3, the percentage stated refers to the area of the surface in which the stripes of a good shade of red characteristic of the variety typically predominates over stripes of lighter red, green or yellow. However, an apple having a color of a lighter shade than that considered as a good shade of red characteristic of the variety may be admitted to a grade, provided it has sufficient additional area covered so that the apple has as good an appearance as one with the minimum percentage of stripes of a good red characteristic of the variety required for the grade. Faded brown stripes are generally not considered as color.

TABLE 3

| | EXTRA FANCY | FANCY |
|---|---|---|
| VARIETY | PERCENT | PERCENT |
| Delicious | 50 | 25 |
| Rome Beauty | 35-50 | 15-33 |
| Wealthy | 50 | 25 |
| Stayman | 50 | 33 |
| Other similar varieties | 50 | 25 |
| Jonathan | 35-66 | 15-33 |
| Mclntosh | 35-50 | 15-33 |
| Cortland | 50 | 33 |
| Akane | 33⅓ | 15 |
| Jonamac | 50 | 33 |
| Nittany | 25 | 10 |
| Vista Bella | 25 | 10 |
| Other similar varieties | 50 | 33 |
| Red sport varieties | 66 | 33-40 |

For the red cheeked or blushed varieties, such as Braeburn, Elstar, Fuji, Gala and Royal Gala, Jonagold, Winter Banana and other similar varieties, “Washington Extra Fancy” apples require a blush cheek, while “Washington Fancy” apples require a tinge of color. For the green or yellow varieties, such as Golden Delicious, for “Washington Extra Fancy” or “Washington Fancy,” grades, 75% or more of the surface of the apple typically will show white or light green predominating over the green color. In “Washington C grade,” 33⅓% or more of the surface of the apple will typically show white or light green predominating over the green color.

In addition to these state guidelines, WAC Chapter 16 includes the state guideline standards for other various fruits that are included in the present disclosure, and is hereby incorporated by reference in its entirety.

In addition to the U.S. federal and Washington state guidelines, the present disclosure also includes international guidelines for fruit standard grades. For example, The European Community Marketing Standards for Fresh Fruits and Vegetables, European Council Regulation No. 2200/1996, which is hereby incorporated by reference in its entirety, sets forth regulations and marketing standards for fresh fruits and vegetables.

Briefly, the EC marketing standards state fresh fruit must be sound, clean and of marketable quality, and that each container or display of produce must be clearly marked with the correct information regarding quality class, origin and—in some cases—variety. For example, apples, apricots, avocados, cherries, citrus fruit, kiwifruit, melons, nectarines, peaches, plums, strawberries, table grapes and watermelons may be classified as part of three main quality classes: Extra Class, Class I and Class II. As used herein, “Extra Class” includes produce of excellent quality and specially selected produce; “Class I” may refer to good quality produce, well-shaped and colored and generally free of blemishes and marks, while “Class II” produce refers to produce of sound marketable quality with certain allowances in relation to shape, coloring and slight minor defects such as blemishes, healed cracks or marks.

In addition other international standards or grades may be used, including the Canadian Agricultural Products Act Fresh Fruit and Vegetable Regulations, (C-0.4/C.R.C.-c.285, Schedule I, §§ 1-56, as amended Aug. 31, 2004), which is hereby incorporated by reference in its entirety.

For example, apples graded in Canada include “Canada Extra Fancy,” “Canada Fancy,” “Canada Commercial,” “Canada Hailed,” “Canada Commercial Cookers,” “Canada No. 1 Peelers” and “Canada No. 2 Peelers.”

As used herein, “Canada Extra Fancy” apples may include apples that are smooth and well formed, are relatively free form bruises; be relatively free from hail damage that has broken the skin or has caused discoloration, be relatively free from limb rub that is depressed, be relatively free from russeting, be relatively free from scab, including pinpoint scab, be relatively free from insect damage, be relatively free from insects and disease, be relatively free from Jonathan spot, drought spot or marks resembling drought spot, be relatively free from sprayburn or sunscald and be relatively free from skin breaks at the stem.

As used herein, “Canada Fancy,” apple grade refers to apples that are relatively smooth and fairly well-formed, relatively free from bruises, relatively free from hail damage, relatively free from limb rub, relatively free from russeting, relative free from pinpoint scab, relatively free from storage scald, relatively free from sprayburn and sunscald, relatively free from insect damage, relatively free from insects, relatively free from Johathan spot, drought spot or marks resembling drought spot and be relatively free from skin breaks at the stem.

As used herein, “Canada Commercial” apple grade refers to apples that are relatively free from bruises, relatively free from hail damage, relatively free from limb rub, relatively free from russeting, relatively free from scab, relatively free from storage scald, relatively free from sprayburn and sunscald, relatively free from drought spot or marks resembling drought spot and relatively free from insect damage.

As used herein, “Canada Hailed” apple grade includes apples that are relatively free from hail damage, and have not less than the amount of color required for “Canada Fancy.”

As used herein, “Canada Commercial Cookers” include apples that meet the standards of the Canada Commercial grade, with the exceptions of russeting and scab, be mature except for Northern Spy varieties, and have a minimum diameter of 63 mm (2½ inches) except for Northern Spy varieties.

As used herein, “Canada No. 1 Peelers” grade refers to apples that are one variety and fairly well formed, are fairly clean, mature and sound; have a minimum diameter of 57 mm (2¼ inches), be relatively free from insect larvae, and be free from any damage or defect.

As used herein, “Canada No. 2 Peelers” include apples that are generally of one variety, are reasonably clean, mature and sound, have a minimum diameter of 57 mm (2¼ inches); be relatively free from insect larvae and be relatively free from any damage or defect.

The color requirement for the Canadian apple standards are set forth in Table 4. In the case of solid red or fully striped varieties, or partially red or partially striped varieties, the apple must be of a red or red striped color on a proportion of their surface area that is at least equal to the percentage set out in Table 4. In the case of red cheeked, blush, green, yellow or russet varieties, the apple must have the minimum shade of color described Table 4.

TABLE 4

| | CANADA | | |
|---|---|---|---|
| COLOR | EXTRA | CANADA | CANADA |
| CATEGORY | FANCY | FANCY | COMMERCIAL |
| Solid red or fully | 65% | 40% | 15% |
| striped varieties | | | |
| Partially red or | 55% | 30% | 15% |
| partially striped | | | |
| varieties | | | |
| Red cheeked or | Perceptibly blush- | Tinge of color | — |
| blush varieties | cheeked | | |
| Green, yellow or | Color | Color | — |
| russet varieties | characteristic of | characteristic | |
| | variety when | of variety when | |
| | mature | mature | |

In addition to the guidelines set forth herein, the present disclosure further relates to other various fruit, the standards for which are included in the U.S. Agricultural Marketing Act of 1946 (as amended), which is hereby incorporated by reference in its entirety, and WAC Chapter 16 of the Washington state guidelines, which is also hereby incorporated by reference in its entirety.

In certain embodiments of the invention, the fruit suitable for flavoring includes cherries. The present disclosure includes the U.S.D.A. guidelines for cherries, such as §§ 51.4340-51.4348 (for red sour cherries) and §§ 51.2646-51.2660 (for sweet cherries) of the Agricultural Marketing Act, as amended, which are hereby incorporated by reference in their entireties. The present disclosure further includes the Washington State Department of Agriculture standards for cherries, as wet forth in WAC Chapter 16, which is hereby incorporated by reference in its entirety. The present disclosure further includes the European and Canadian standards for cherries, described in the documents cited herein which were previously incorporated by reference.

For example, cherries used in any embodiments of the present disclosure may include the grade of “U.S. No. 1,” or “U.S. Commercial” grade according to the U.S.D.A. federal regulations, “Washington No. 1” or “Northwest No. 1,” according to the Washington state guidelines, or another grade.

In another example, peaches used in any embodiments of the present disclosure may include the grade of “U.S. Grade A” or “U.S. Fancy;” “U.S. Grade B” or “U.S. Choice;” “U.S. Grade C” or “U.S. Standard;” “U.S. Grade D” or “U.S. Substandard;” “U.S. No. 1;”“U.S. No. 2;” “Washington Extra Fancy,” “Washington Fancy,” or another grade.

In addition to these guidelines, the present invention may be practiced with any number of other federal, state or local guidelines for fruit and/or vegetables. Such guidelines may include those established under NAFTA, the United Nations, other treaties or other laws.

In one embodiment, fruit suitable for flavoring will have soluble solids measurement of fruit sugar content of 12-14 brix or higher, for apples. In one particular embodiment, the test of soluble solids measurement of fruit sugar content is 12 brix or higher. In another particular embodiment, the test of soluble solids measurement of fruit sugar content is 13 brix or higher. In yet another embodiment, the test of soluble solids measurement of fruit sugar content is 14 brix or higher.

One of skill in the art will recognize that whole fruit size may be measured in a number of ways. In particular, the diameter of whole fruit size may be measured, carton “count” may be measured, or its packaged weight may be measured. An exemplary embodiment of the present invention includes apples that measure from 2 to 4 inches in diameter. If the whole fruit size is measured as a “count” of fruit per standard 40 or 48 lb. carton, or its metric equivalent, fruit size for one example embodiment of the invention is from 72 count to 163 count. In another particular embodiment, the measurement of whole fruit size is 100 count or less. In another particular embodiment, the measurement of whole fruit size is 150-48 lb, or its metric equivalent.

One of skill in the art will also recognize that measuring fruit acidity may, alone or in combination with other factors, indicate the quality of the fruit suitable for flavoring. In an exemplary embodiment of the present invention, wherein the fruit is an apple, the fruit acidity is in the range of pH 1.5-6.0. In another particular embodiment, the fruit acidity is in the range of pH 4.0-7.0.

One of skill in the art will further recognize measuring starch content may, alone or in combination with other factors, indicate the quality of the fruit suitable for flavoring. In an example embodiment, wherein the fruit is an apple, the fruit starch content is in the range of 1.0-6.0. In another embodiment, the fruit starch content is in the range of 2.5-3.0.

As one of skill in the art would recognize, measuring fruit firmness, alone or in combination with other factors, may indicate quality of the fruit suitable for flavoring. In an exemplary embodiment, wherein the fruit is an apple, the fruit firmness is in the range of 10 force pounds (lbf) or higher. In another embodiment, the fruit firmness is in the range of 11 force pounds (lbf) or higher. In another embodiment, the fruit firmness is in the range of 10-17 force pounds (lbf).

In another particular embodiment, the presently claimed invention also relates to pears and methods of qualifying pears for subsequent flavoring. The present disclosure includes standards for grades of pears as described by the U.S. Department of Agriculture (§§ 51.1345-51.1359 of the Agricultural Marketing Act as amended, and §§ 51.1300-51.1323 of the Agricultural Marketing Act, as amended), which are hereby incorporated by reference in their entireties.

In general, and as used herein, “U.S. Extra No. 1” pears include fruit of one variety which are mature, but not overripe, carefully hand-picked, clean, well formed, relatively free from decay, internal breakdown, scald, freezing injury, worm holes, black end, hard end, drought spot, and relatively free from injury caused by russeting, limb rubs, hail, scars, cork spot, sunburn, sprayburn, stings or other insect injury, or mechanical or other means, except that they shall be relatively free from damage caused by bruises, broken skins, or disease.

In general, and as used herein, “U.S. No. 1” for fresh pears includes pears of one variety which are relatively mature, but not overripe, carefully hand-picked, clean, fairly well formed, relatively free from decay, internal breakdown, scald, freezing injury, worm holes, black end, and from damage caused by hard end or broken skins. The “U.S. No. 1” fresh pears are also generally free from serious damage caused by bruises, russeting, limb rubs, hail, scars, cork spot, drought spot, sunburn, sprayburn, stings or other insect injury, disease, or mechanical or other means.

In general, and as used herein, “U.S. No. 1” for processing pears includes pears of one variety which are relatively mature, handpicked, firm, well formed, free from scald, hard end, black end, internal breakdown, decay, worms and worm holes, and from damage caused by broken skins, limb rubs, sprayburn, sunburn, scab, russeting, bruises, hail, frost, drought spot, disease, insects, mechanical or other means. Unless otherwise specified, the “U.S. No. 1” pears for processing are generally not further advanced than yellowish green. In general, tree-ripened pears and pears grown from late blooms are not considered as meeting the requirements of this grade.

In general, and as used herein, “U.S. No. 2” for processing pears includes pears of one variety which are relatively mature, hand-picked, firm, not seriously deformed, free from scald, hard end, black end, internal breakdown, decay, worms and worm holes, and free from serious damage by any other cause. Unless otherwise specified, the pears in this grade are not further advanced than yellowish green. In general, tree-ripened pears and pears grown from late blooms shall not be considered as meeting the requirements of this grade.

In general, and as used herein, “Unclassified” includes pears which have not been classified in accordance with any of the foregoing grades. As such, “Unclassified” is not a grade within the meaning of the U.S.D.A. standards, but is provided to designate that no grade has been applied to the lot. In addition, “culls” are pears which do not meet the requirements of any of the foregoing grades for fresh or processing pears.

As used herein, “serious damage” may refer to any injury or defect which seriously affects the appearance, or the edible or shipping quality. In addition, for processing pears, “serious damage” cannot be removed during the usual commercial preparation for use without a loss of over 20%, by weight, of the pear in excess of that which would occur if the pear were not defective.

As with any fruit, decay, scald or other deterioration which may have developed on pears after they have been in storage or transit are generally considered as affecting condition and not the grade.

As used herein to describe pears, “mature” generally refers to pears that have reached the stage of maturity which will insure the proper completion of the ripening process, and before the fruit has become overripe it will show varying degrees of firmness depending on the stage of the ripening process. Thus, a description of firmness may also be given in order to indicate the stage of the ripening process.

In referring to the firmness of pears, “hard” means the flesh of the pear is solid and does not yield appreciably even to considerable pressure; “firm” means that the flesh of the pear is fairly solid but yields somewhat to moderate pressure but is not wilted, shriveled, rubbery or flabby; “firm ripe” means that the flesh of the pear yields readily to moderate pressure; “ripe” means that the pear is at the stage where it is in its most desirable condition for eating; “overripe” means dead ripe, very mealy or soft, past commercial utility. Generally, a description of the ground color may also be given, according to “green,” “light green,” “yellowish green,” and “yellow.”

As used herein, “hand-picked” may refer to fruit that does not show evidence of having been on the ground, and “carefully hand-picked” may refer to fruit that shows no evidence of rough handling or of having been on the ground. As used herein, “black end” is indicated by an abnormally deep green color around the calyx, or black spots usually occurring on the one-third of the surface nearest to the calyx, or by an abnormally shallow calyx cavity.

In at least one embodiment, the fruit is not a pome fruit. In at least one embodiment, the fruit is not an apple. In at least one embodiment, the fruit is not a pear.

One of skill in the art would recognize that the test of soluble solids measurement of fruit sugar content in raw pears may be immeasurably low due to incomplete ripening. Pear size may be measured as individual fruit size or whole packaged size or weight. In particular, the measurement of individual fruit size may be from 2 to 4 inches in diameter. Alternatively, the whole fruit size as measured by a “count” of fruit per standard 40 or 48 lb. carton, or its metric equivalent, may be from 72 count to 163 count. In one particular embodiment, the measurement of whole fruit size is 100 count or less. In another particular embodiment, the measurement of whole fruit size is 150-48 lb, or its metric equivalent.

One of skill in the art would recognize that fruit acidity, alone or in combination with other factors, may indicate fruit quality in fruit suitable for flavoring. In a particular embodiment, the fruit acidity of the pear used is in the range of pH 1.5-6.0. In another particular embodiment, the fruit acidity of the pear is in the range of pH 4.0-7.0.

One of skill in the art would recognize other factors in determining fruit quality are fruit starch and/or fruit firmness in fruit suitable for flavoring. In particular, the fruit starch content of a pear used in the present invention is in the range of 1.0-6.0. In any particular embodiment, the firmness of the pear is in the range of 8 force pounds (lbf) or higher.

In the particular embodiment wherein the fruit is a pear, the fruit has a United States Department of Agriculture federal grade selected from the group consisting of: U.S. Extra No. 1, U.S. No. 1, and any combination thereof. Alternatively, the fruit used to practice the presently claimed invention has any state or federal grade available.

In another particular embodiment, the present invention relates to Asian pears. One of skill in the art would recognize that Asian pears include “Tsu Li,” “Ya Li,” “Kikusui,” “Nijisseiki,” “20^{th} Century,” “Seigyoku,” “Shinseiki,” “Chojuro,” “Doitsu,” “Imamura Aki,” “Hosui,” “Kosui,” “Niitaka,” “Shinko,” “Ishiiwase,” and other Chinese or Japanese varieties or cultivars. Other common names for Asian pears include Oriental pears, Chinese pears, Japanese pears, nashi, sand apples, salad pears, “apple pears,” and others.

In certain aspects of this invention, Asian pears that are suitable for flavoring have a firmness of approximately 7-25 lbs. In certain aspects of the invention, the Asian pears have a firmness of approximately 7 lbs, 8 lbs, 9 lbs, 10 lbs, 11 lbs, 12 lbs, 13 lbs, 14 lbs, 15 lbs, 16 lbs, 17 lbs, 18 lbs, 19 lbs, 20 lbs, 21 lbs, 22 lbs, 23 lbs, 24 lbs, 25 lbs, or any value therebetween.

In certain aspects of this invention, the Asian pears that are suitable for flavoring may have approximately 11-14% soluble solids. In certain aspects, the Asian pears that are suitable for flavoring may have approximately 11.0%, 11.5%, 12.0%, 12.5%, 13.0%, 13.5%, 14.0%, 14.5% soluble solids or any value therebetween or greater.

One of skill in the art would recognize a variety of other factors may be considered in determining the quality control of Asian pears suitable for flavoring.

In another particular embodiment, the present invention also relates to cherries. In certain aspects of this embodiment, the fruit sugar content of cherries suitable for flavoring is approximately 10-27%. In certain aspects of this embodiment, the fruit sugar content of cherries suitable for flavoring is approximately 10%, 11%, 12%, 13%, 14%, 15%, 16%, 17%, 18%, 19%, 20% 21%, 22%, 23%, 24%, 25%, 26%, 27% or any value therebetween. As one of skill in the art would understand, total soluble solids content may also be measured in ° Brix, rather than percentage, and thus the present disclosure includes the total soluble solids content for cherries suitable for flavoring as approximately 10.5 to 16° Brix. In certain aspects of the invention, the total soluble solids content may be approximately 10.5°, 11.0°, 12.0°, 13.0°, 14.0°, 15.0°, 16.0° Brix, or any value therebetween or greater.

In certain aspects of the invention, the fruit firmness for cherries suitable for flavoring is approximately 4.0 N to 7.5 N. In certain aspects of this embodiment, the fruit firmness for cherries suitable for flavoring is approximately 4.0 N, 4.5 N, 5.0 N, 5.5 N, 6.0 N, 6.5 N, 7.0 N, 7.5 N or any value therebetween. In certain aspects of the invention, the pH of cherries suitable for flavoring may be approximately 3.0 to 5.0. In certain aspects of the invention, the pH of cherries suitable for flavoring may be approximately 3.0, 3.5, 4.0, 4.5, 5.0, or any value therebetween.

One of skill in the art would recognize that other factors may also be considered when determining the quality control of cherries or other fruit that is suitable for flavoring.

Cleaning Fruit

At least one embodiment of the present invention also relates to a method for flavoring raw fruit, comprising cleaning said fruit, cutting said fruit into segments and contacting said fruit segments with one or more flavoring agents, wherein said cleaning removes excess dirt, dust, chemical residues or other foreign material from said fruit. In one particular embodiment, the fruit is cleaned prior to cutting it into segments. In another particular embodiment, the fruit is cleaned simultaneously with cutting it into segments. The step of cleaning comprises removing excess dirt, dust, chemical residues or other foreign material from the fruit. One of skill in the art is well apprised of general methods for cleaning fruit, including—but not limited to—floating the uncut fruit in chlorinated or non-chlorinated water, spraying the uncut fruit with chlorinated or non-chlorinated water, spraying the uncut fruit with a dilute solution of sodium hypochlorite, removing the stem from the fruit (destemming), or any combination thereof.

Cutting Fruit

The present invention also relates to a method for flavoring raw fruit, comprising cutting said fruit into segments and contacting said fruit segments with one or more flavoring agents, wherein said cutting comprises using a device with metal blades that cores and/or cuts said fruit into said segments. In one particular embodiment, the device cores and cuts the fruit simultaneously. Because fruit appearance is important for consumer satisfaction, one embodiment of this aspect includes cutting the fruit with a device that cuts the fruit with a minimum of damage to the fruit segments. A further embodiment includes cutting the fruit with a device which cores and cuts the fruit with a minimum of edible fruit lost.

Another embodiment includes utilizing a cutting device that further comprises a pin to guide the fruit into position for cutting. A further embodiment includes a pin that holds the fruit by its center or core, thereby allowing the outer portion of the fruit to be cut. In one embodiment, the device for cutting fruit holds a plurality of blades.

In certain embodiments of the present disclosure, a cutting device comprises a laser to assist in guiding the fruit into position for cutting. Such laser may be used alone or in combination with other means for guiding the fruit into position for cutting.

In the same or another embodiment, the device operates by air pressure or water pressure. One such apparatus that is appropriate for use with the present invention is described in U.S. Patent Application No. 20050031748, herein incorporated by reference. Briefly, the cutting device described in U.S. Patent Application No. 20050031748 includes two twin-opposed coaxial guide pins which are positioned on the top and bottom regions of the fruit. A compressive force between the pins is applied so as to secure the fruit in a stationary position throughout the cutting and/or coring process. As the fruit remains secured, a plurality of knives or blades are pressed through the fruit, thus slicing it. Such a slicer may also have further adjustments as needed, depending on the particular fruit to be sliced and/or cored. For example, the device may contain a conical edge to firmly secure fruit that is already cored. It may also contain a solid pin that is fixed to the radial center of the blade mechanism so that fruit that is not yet cored may be cut and/or cored depending on the pattern or positioning of the blades.

Another apparatus that may be used with the presently claimed invention is the Sunkist® Citrus Slicer. The Sunkist® Citrus Sectionizer is a food slicer that allows for fruit or vegetables to be cut by placing in a flexible collar and pressing down the handle which manually forces the blades through the fruit. The slicer may include a 4 wedge evenly spaced blade (#S-101), a 6 wedge evenly spaced blade (#S-102), a 6 slices 5/16 inches thick (#S-103), a 8 wedge evenly spaced blade (#S-104), a 3 in 1, which cuts two halves and scores three wedges (#S-105), or a single, which cuts fruit in half (#S-107).

In another embodiment, the fruit may be cut manually (by hand with a knife), by automated machine, or any combination of the modes described herein.

The present invention relates to compositions, methods and kits for flavoring raw, cut, fruit segments, wherein the segments may be selected from the group consisting of slices, rings, chunks, wedges, quarters, halves, any other piece and any combination thereof. For any embodiment of the presently claimed invention, the fruit may be peeled or unpeeled.

In one embodiment of the present invention, the fruit segments are slices. Such fruit slices may each be uniform in thickness, or may vary in thickness, and include matchstick-sized slices. In another particular embodiment, the fruit segments are rings. Such fruit rings may each be uniform in thickness, or may vary in thickness. In another particular embodiment, the fruit segments are chunks. Such fruit chunks may each be the same size or may vary in size. In another particular embodiment, the fruit segments are wedges. Such fruit wedges may each be the same size or may vary in size. In another particular embodiment, the segments are quarters. In another particular embodiment, the fruit segments are halves. In another particular embodiment, the fruit segments are a combination of slices, rings, chunks, wedges, quarters, and halves.

One of skill in the art would recognize that the raw, cut, flavored fruit segments may be cut into a desired size or sizes, or cut into a particular shape or shapes. Particular shapes may include, but not be limited to, geometric figures, animals, cartoon characters, symbols, designs, logos, emblems, words, or the like.

In addition to or instead of cutting the fruit into desired sizes and/or shapes, the raw, cut, flavored fruit segments of the present invention may have imprints impressed into them. The imprints or impressions may be colored or uncolored. If the imprints or impressions are colored, they may be colored the same color as the surrounding fruit, or they may be colored differently from the surround fruit, and the imprints may be colored with one or more colors. The imprints or impressions may include, but not be limited to, decorations, geometric shapes, cartoon characters, animals, logos, emblems, words, slogans, symbols, designs, or the like.

The colors used herein for the raw, cut, flavored fruit segments include natural or artificial colors. In one embodiment, the colors are of edible food grade dye. In another particular embodiment, the fruit segment colors are not edible and are used as fruit decorations. Some colors which may be used with the present invention include Red, Pink, Gray, Orange, Yellow, Green, Blue, White, Indigo, Violet (Purple), Black, fluorescent or neon versions of any color, shades, tones or tints of any color, and any combinations of colors.

As one of skill in the art will recognize, the colorant may take any particular form, including solid, liquid, gas, gel, paste, or any other form disclosed herein for use with the flavoring. In addition, one of skill in the art would recognize that colorants may be water-soluble dyes or pigments; an aluminum lake pigment that may be dispersed in oils, fats, or other carriers such as propylene glycol, glycerin or a sucrose suspension; oil-soluble dyes or pigments, as well as others, or any combination thereof. The colorants of the present invention may be natural, artificial, organic, inorganic, or any combination thereof.

Some examples of “natural” colorants that may or may not be edible include beet, paprika, annatto, tumeric, cabbage, caramel, and others. Some examples of pigments that are not edible include azo dyes, phthalocyanine, quinacridone, molybdate orange, chromium yellow, chromocyanine green, mica, iron oxide, titanium dioxide, and others.

More specifically, some edible colorants include, but are not limited to, Food, Drug & Cosmetic (FD&C) Blue 1, FD&C Green 3, FD&C Yellow 3, FD&C Yellow 4, FD&C Yellow 5, FD&C Yellow 1, FD&C Yellow 10, FD&C Yellow 6, FD&C Red 7, FD&C Blue 2, FD&C Red 3, FD&C Red 2, FD&C Red 14, FD&C Red 40, FD&C Red 4, FD&C Red 9, FD&C Red 22, FD&C Red 28, FD&C Yellow 13, FD&C Blue 1, FD&C Brown 2, FD&C Blue 5, FD&C Brown 3, FD&C Green 5, FD&C Green 6, FD&C Red 17, FD&C Blue 15, FD&C Green 4, FD&C Black 1, and any combination thereof.

Some colorants that may be used with the present invention but are inedible include, but are not limited to, Drug and Cosmetic (D&C) Green 5, D&C Green 6, D&C Green 8, D&C Red 28, D&C Red 30, D&C Red 33, D&C Yellow 10, and any combination thereof.

The present invention may be practiced with peeled or unpeeled fruit. If peeled fruit is used to practice the present invention, the fruit may be peeled prior to, simultaneously with, or subsequent to cutting it into segments and/or flavoring the fruit. In one particular embodiment, the fruit is peeled prior to cutting it into segments and/or flavoring the fruit. In another particular embodiment, the fruit is peeled simultaneously with cutting it into segments and/or flavoring the fruit. In another particular embodiment, the fruit is peeled subsequent to cutting it into segments and/or flavoring the fruit.

The present invention may be practiced with cored or uncored fruit. If cored fruit is used to practice the present invention, the fruit may be cored prior to, simultaneously with, or subsequent to cutting it into segments and/or flavoring it. In one particular embodiment, the fruit is cored prior to cutting it into segments and/or flavoring it. In another particular embodiment, the fruit is cored simultaneously with cutting it into segments and/or flavoring it. In another particular embodiment, the fruit is cored subsequent to cutting it into segments and/or flavoring it.

The present invention may be practiced with pitted or unpitted fruit. If pitted fruit is used to practice the present invention, the fruit may be pitted prior to or simultaneously with cutting it into segments and/or flavoring it. In one particular embodiment, the fruit is pitted prior to cutting it into segments and/or flavoring it. In another particular embodiment, the fruit is pitted simultaneously with cutting it into segments and/or flavoring it.

The present invention may be practiced with stoned or unstoned fruit. If stoned fruit is used to practice the present invention, the fruit may be stoned prior to or simultaneously with cutting it into segments and/or flavoring it. In one particular embodiment, the fruit is stoned prior to cutting it into segments and/or flavoring it. In another particular embodiment, the fruit is stoned simultaneously with cutting it into segments and/or flavoring it.

At least one embodiment relates to raw, cut or uncut, flavored fruit segments or fruit. Such flavored fruit or fruit segments may be used for direct human consumption, or may be processed for cakes, cookies, breads, cereals, other baked goods, cake mixes, jams, jellies, yogurt mixes, or other food add-ins or other processed food(s).

Anti-Browning Agent

The present invention also relates to compositions and methods of flavoring raw, cut or uncut fruit segments or fruit, wherein said fruit segments or fruit are contacted with at least one anti-browning agent prior to, simultaneously with, or subsequent to cutting into segments and/or flavoring the fruit. In one particular embodiment, the raw fruit is contacted with at least one anti-browning agent prior to cutting into segments and/or flavoring the fruit. In another particular embodiment, the raw fruit is contacted with one or more anti-browning agents simultaneously with cutting into segments and/or flavoring the fruit. In another particular embodiment, the fruit is contacted with at least one anti-browning agent subsequent to cutting into segments and/or flavoring the fruit.

At least one embodiment of the present invention also relates to compositions and methods of flavoring raw, cut or uncut fruit segments or fruit, wherein said fruit segments or fruit are contacted with one or more anti-browning agents prior to, simultaneously with, or subsequent to flavoring. In one particular embodiment, the raw, cut or uncut, fruit segments or fruit is contacted with one or more anti-browning agents prior to flavoring. In another particular embodiment, the raw, cut or uncut fruit segments or fruit is contacted with one or more anti-browning agents simultaneously with flavoring. In another particular embodiment, the raw, cut or uncut fruit segments or fruit is contacted with one or more anti-browning agents subsequent to flavoring.

One of skill in the art would readily recognize the present invention may be practiced with a variety of anti-browning agents including, but not limited to, citric acid; NatureSeal™ (for example, as described in U.S. Pat. No. 5,925,395, which is hereby incorporated by reference); vitamin(s); mineral(s); ascorbic acid; potassium sorbate; enzymes; acids; bases; erythorbic acid; calcium; sulfur dioxide; sulfites; benzoic acid; Freshxtend™ (a proprietary blend of vitamins and minerals, including vitamin C and calcium chloride that is available from Fortitech, Inc.) other antioxidants such as butylated hydroxyanisole (BHA), butylated hydroxytoluene (BHT), tert-butylhydroquinone (TBHQ), propyl gallate, ascorbyl palmitate; or any combination thereof. Further examples of anti-browning agents that may be used with the present invention include those described in U.S. Pat. No. 5,939,117, which is hereby incorporated by reference in its entirety.

In addition to any anti-browning qualities achieved by adding vitamins and/or minerals, at least one vitamin and/or mineral may be added to the fruit segments for additional nutrition. Any added vitamin(s) and/or mineral(s) may take any form herein described for anti-browning agents or flavoring agents (e.g. solid, liquid, gas, gel, etc.), and may be applied by any mode described herein for anti-browning agents or flavoring agents (spraying, immersing, etc.).

The one or more anti-browning agent may take any form or combination of forms. For example, the anti-browning agent form may include, but not be limited to, a liquid, solid, gel, gas, syrup, paste, and the like, or any combination thereof, that directly or indirectly contacts the fruit. In one particular embodiment, the one or more anti-browning agents may be diluted prior to use. In another particular embodiment, the one or more anti-browning agents may be used without diluting.

The one or more anti-browning agents may contact uncut fruit or cut fruit segments. The uncut fruit may be peeled or unpeeled, cored or uncored, pitted or unpitted, stoned or unstoned. One of skill in the art would recognize the present invention includes the one or more anti-browning agents penetrating the entire uncut fruit or cut fruit segment. Alternatively, the present invention includes the one or more anti-browning agents penetrate less than the entire uncut fruit or cut fruit segment.

One of skill in the art would recognize the anti-browning agent(s) may take a variety of forms. For example, the agent(s) may be in the form of a liquid. Such liquid may be water-based, alcohol based, glycerol based, glycol-based, or fat or oil-based. In one particular embodiment, the liquid is heated to produce anti-browning agent vapor to which the fruit is contacted.

For example, the one or more anti-browning agents may be in the form of a solid. In one embodiment, the anti-browning agent is a powder, flake, ribbon, film, fiber, string, capsule, bead, microbead, tablet, pellet or shavings. In one embodiment, the anti-browning agent is a tablet that may be soaked in a liquid. In another embodiment, the anti-browning agent is dusted on the fruit segments.

In another particular embodiment, the one or more anti-browning agents are in the form of a gas, including atomizing. In a further embodiment, the gas vapor is pumped onto or around the uncut fruit or cut fruit segments.

In another exemplary embodiment, the one or more anti-browning agents are adhered to the surface or embedded in a porous or nonporous pad or surface. In a further embodiment, the anti-browning agent gas is released by wetting the porous or nonporous pad or surface. In another particular embodiment, the anti-browning agent gas is released by heating the porous or nonporous pad or surface. In another further embodiment, the porous or nonporous pad or surface further comprises an adhesive.

Finally, in another example, the one or more anti-browning agents take the form of a gel. Such gel may include gelatin-based or polymerized glycol. In another particular embodiment, the anti-browning agent takes the form of a paste. In another particular embodiment, the anti-browning agent takes the form of an edible matrix or adhesive. One example of such edible adhesive is described in U.S. Pat. No. 5,827,553, hereby incorporated by reference in its entirety. In another embodiment, the anti-browning agent is in the form of a xanthan gum or carrageen base.

One of skill in the art would recognize a number of techniques by which the uncut fruit or cut fruit segments may contact one or more anti-browning agents. For example, the uncut fruit or cut fruit segments may contact one or more anti-browning agents by immersing the fruit in the anti-browning agent(s), by rolling the uncut fruit or cut fruit segments in the anti-browning agent(s), by shaking the uncut fruit or fruit segments in the anti-browning agent(s), by injection of the anti-browning agent(s) into the uncut fruit or cut fruit segments, by brushing or spraying the anti-browning agent(s) on the uncut fruit or cut fruit segments.

In one particular embodiment, the one or more anti-browning agent(s) further comprise one or more natural, artificial or organic sweeteners. Such natural, artificial or organic sweeteners are well known to one of skill in the art and include, but are not limited to, white cane sugar or syrup, brown sugar or syrup, dextrose, glucose, lactose, whey, ribose, xylose, xylitol, rhamnose, date sugar, white or brown rice syrup, malt, molasses or molasses powder, honey, dehydrated honey, corn syrup or corn syrup solids, high fructose corn syrup, fructose, saccharin, Splenda™ (sucralose), NutraSweet™ (aspartame), acesulfame-K, stevia, Shugr™ (a mixture of erythritol, maltodextrin and sucralose), any modification of these sweeteners, any combination thereof, and the like.

In one particular embodiment, the one or more anti-browning agents further comprise at least one natural, artificial or organic color. Such natural, artificial or organic colors are well known to one of skill in the art and include, but are not limited to, colors certified by the U.S. Food and Drug Administration (FDA), colors not certified by the U.S. FDA, colors that are edible dyes, colors that are not edible dyes and are used for non-edible purposes, or any combination thereof.

Some colors which may be used with the present invention include Red, Pink, Grey, Orange, Yellow, Green, Blue, White, Indigo, Violet (Purple), Black, fluorescent or neon versions of any color, shades, tones or tints of any color, and any combinations of colors.

As one of skill in the art will recognize, the colorant may take any particular form, including solid, liquid, gas, gel, paste, or any other form disclosed herein for use with the flavoring. In addition, one of skill in the art would recognize that colorants may be water-soluble dyes or pigments; an aluminum lake pigment that may be dispersed in oils, fats, or other carriers such as propylene glycol, glycerin or a sucrose suspension; oil-soluble dyes or pigments, as well as others, or any combination thereof. The colorants of the present invention may be natural, artificial, organic, inorganic, or any combination thereof.

Some examples of “natural” colorants that may or may not be edible include beet, paprika, annatto, tumeric, cabbage, caramel, and others. Some examples of pigments that are not edible include azo dyes, phthalocyanine, quinacridone, molybdate orange, chromium yellow, chromocyanine green, mica, iron oxide, titanium dioxide, and others.

More specifically, some edible colorants include, but are not limited to, Food, Drug & Cosmetic (FD&C) Blue 1, FD&C Green 3, FD&C Yellow 3, FD&C Yellow 4, FD&C Yellow 5, FD&C Yellow 1, FD&C Yellow 10, FD&C Yellow 6, FD&C Red 7, FD&C Blue 2, FD&C Red 3, FD&C Red 2, FD&C Red 14, FD&C Red 40, FD&C Red 4, FD&C Red 9, FD&C Red 22, FD&C Red 28, FD&C Yellow 13, FD&C Blue 1, FD&C Brown 2, FD&C Blue 5, FD&C Brown 3, FD&C Green 5, FD&C Green 6, FD&C Red 17, FD&C Blue 15, FD&C Green 4, FD&C Black 1, and any combination thereof.

Some colorants that may be used with the present invention but are inedible include, but are not limited to, Drug and Cosmetic (D&C) Green 5, D&C Green 6, D&C Green 8, D&C Red 28, D&C Red 30, D&C Red 33, D&C Yellow 10, and any combination thereof.

In another particular embodiment, the one or more anti-browning agents further comprise a flavor enhancer. Such flavor enhancers are well known to one of skill in the art and include, but are not limited to, natural or artificial sweeteners, monosodium glutamate (MSG), disodium glutamate (DSG), inosine 5′monophosphate (IMP), guanosine 5′monophosphate (GMP), D-tagatose, any combination thereof, or the like.

Timing for Anti-Browning

At least one aspect of the presently claimed invention also relates to a method for flavoring raw fruit, comprising cutting said fruit into segments and contacting said fruit segments with one or more anti-browning agents, wherein said fruit segments are exposed to air for 24 hours or less prior to contacting said anti-browning agents. In one particular embodiment, the raw, cut fruit segments are exposed to air for about ten minutes, for about five minutes, for about three minutes, for about two minutes, for about one minute or less prior to contacting one or more anti-browning agents. In another particular embodiment, the raw, cut fruit segments are exposed to air for about one minute or less prior to contacting one or more anti-browning agents. In another particular embodiment, the raw, cut fruit segments are exposed to air for about 30 seconds, for about 10 seconds, for about 1 second or less prior to contacting one or more anti-browning agents. In another particular embodiment, the raw, cut fruit segments are exposed to air for between about 3-5 seconds prior to contact with one or more anti-browning agents. In another particular embodiment, the raw, cut fruit segments are exposed to air for between about 1-60 seconds prior to contact with one or more anti-browning agents.

Flavoring

In at least one embodiment, the present invention also relates to methods of flavoring raw, cut fruit segments, and compositions of the same, wherein the flavoring agent(s) include, but are not limited to, apple, chocolate, rum, triple sec, peppermint, ginger, orange, lemon, lime, blueberry, blackberry, strawberry, margarita, pina colada, daiquiri, cherry, root beer, butterscotch, peanut butter, vodka, gin, whiskey, brandy, cheese, wine flavors (such as merlot, cabernet, chardonnay, etc.), smoked, barbeque, chipotle, ranch, curry, vanilla, mint, cinnamon, apple pie, raspberry, maple, grape, cola, caramel, mango, kiwi, English Toffee, cocoa, tropical flavors, bubble gum, peach, coconut, bergamot, cinnamon bark, ginger ale, grapefruit, lemon-lime, mandarin, sweet orange, triple sec, almond butter, butter pecan, coffee, cream, honey, peanut, guava, amaretto, Asian Blender, Crème de Menthe, Kalamansi, Sloe berry, Chai Tea, Tequila, white strawberry, white cranberry, ginger, white grape, guarana, jasmine, malted milk, mint, orange juice, orange sherbet, Oriental Herbal, punch, sugar, tropical fruit, Chichamorada, Cherimoya, Ginseng mint, melon, papaya, Ming Tea, Sweet Musk melon, pandan, tamarind, tangerine, strawberry kiwi, guanabana, peach apricot, Apple strudel, chocolate cherry, chocolate mint, French vanilla, licorice, minty melon, Amaretto, chocolate fudge, green bell pepper, Muscat, baby powder, Boston Crème, cantaloupe, cheesecake, chocolate hazelnut, cologne, hazelnut, pine oil, pizza, sesame oil, pumpkin spice, rose, brown sugar, sweet roll, tropical punch, vanilla cream, Bleu Cheese, melted butter, sweet butter, roasted chicken, milk chocolate, toasted coconut, ginger snap, graham cracker, mushroom, pecan, pistachio, red raspberry, blue raspberry, strudel, wafer, walnut, Royal cream, sour cream, dry apricot, caramel corn, cotton candy, cranapple, Temple orange, fresh pineapple, black raspberry, fresh strawberry, passion fruit, wildberry, orange cream, sweet cherry, banana, mango, wild raspberry, wild blueberry, wild blackberry, root beer cream, cola cream, carrot, carrot cake, pumpkin, “buttery” versions of any flavors described herein, any flavors described herein with cinnamon or extra cinnamon or other spice, or any combination thereof.

As one of skill in the art would recognize, flavoring agents may be obtained from any number of producers or manufacturers. In some circumstances, the exact chemical formulation for the flavoring agent may be proprietary. In other circumstances, the exact chemical formulation may be known or obtainable. Some examples of flavorings for which the chemical formula is known include benzaldehyde (C₆H₅CHO) and benzyl chloride (C₇H₇Cl).

In at least one embodiment, the flavoring and/or anti-browning agent is not methyl anthranilate (also referred to as methyl-o-aminobenzoate, neroli oil, or 2-Aminobensoic acid methyl ester).

The flavoring agent may be diluted or directly applied to the fruit segment. The flavoring agent may penetrate the entire fruit segment, or it may penetrate less than the entire fruit segment.

The flavoring agent used to practice the presently claimed invention may be natural, artificial or organic. One of skill in the art would readily appreciate that the flavoring agent may take any form, including but not limited to, liquid, syrup, droplet, solid, gas, gel, paste, or any combination thereof.

In one particular embodiment, the flavoring agent takes the form of a liquid. Such liquid form may be water-based, alcohol-based, glycerol-based, glycol-based, or fat or oil-based. In one particular embodiment, the liquid is heated to produce flavoring agent vapor to which the fruit is contacted.

In another particular embodiment the one or more flavoring agents are in the form of a solid. In one further embodiment, the flavoring agent is a powder, flake, ribbon, film, fiber, string, capsule, bead, microbead, tablet, pellet or shavings. In one embodiment, the flavoring agent is a tablet that may be soaked in a liquid. In another embodiment, the flavoring agent is dusted on the fruit segments.

In another particular embodiment, the one or more flavoring agents are in the form of a gas, such as atomizing. In a further embodiment, the gas vapor is pumped onto or around the uncut fruit or fruit segments.

In another particular embodiment, the one or more flavoring agent(s) are adhered to the surface or embedded in a porous or nonporous pad or surface. In a further embodiment, the flavoring agent gas is released by wetting the porous or nonporous pad or surface. In another particular embodiment, the flavoring agent gas is released by heating the porous or nonporous pad or surface. In another further embodiment, the porous or nonporous pad or surface further comprises an adhesive. In another particular embodiment, the one or more flavoring agent resides inside a crushable ampule that may or may not be edible.

In another particular embodiment, the one or more flavoring agents are in the form of a gel. Such gel may include gelatin-based or polymerized glycol-based. In another particular embodiment, the flavoring agent takes the form of a paste. In another particular embodiment, the flavoring agent takes the form of an edible matrix or adhesive. One example of such edible adhesive is described in U.S. Pat. No. 5,827,553, which is hereby incorporated by reference in its entirety. In a further embodiment, the flavoring agent is in the form of a xanthan gum or carrageen base.

One of skill in the art would recognize the flavoring agents may contact the raw, cut or uncut, fruit segments or fruit in a variety of ways, including by immersing the fruit segments in the flavoring agents, by rolling the fruit segments in the flavoring agents, by shaking or spinning the fruit segments in the flavoring agents, by dusting the fruit segments with powdered flavoring agent, by injecting the flavoring agents into the cut fruit segments, by brushing or spraying the agents on the cut fruit segments or by misting the agents on the cut fruit segments.

In one particular embodiment, the one or more flavoring agents further comprise one or more natural, artificial or organic sweetener(s). Such natural, artificial or organic sweeteners are well known to one of skill in the art and include, but are not limited to, white cane sugar or syrup, brown sugar or syrup, dextrose, glucose, lactose, whey, ribose, xylose, xylitol, rhamnose, date sugar, white or brown rice syrup, malt, molasses or molasses powder, honey, corn syrup or corn syrup solids, high fructose corn syrup, fructose, saccharin, Splenda™ (sucralose), NutraSweet™ (aspartame), acesulfame-K, stevia, Shugr™ (a mixture of erythritol, maltodextrin and sucralose, any modification of these sweeteners, any combination thereof, and the like.

In one particular embodiment, the one or more flavoring agents further comprise at least one natural, artificial or organic color. Such natural, artificial or organic colors are well known to one of skill in the art and include, but are not limited to, colors certified by the U.S. Food and Drug Administration (FDA), colors not certified by the U.S. FDA, colors that are edible dyes, colors that are not edible dyes and are used for non-edible purposes, or any combination thereof. Some examples of such colorants are described previously herein.

One of skill in the art would readily recognize that the raw, cut fruit segments may be contacted with one or more flavoring agents in a variety of ways, including but not limited to immersing the raw, cut fruit segments in the flavoring agent; rolling the raw, cut fruit segments in the flavoring agent; shaking the raw, cut fruit segments with the flavoring agent; spinning the raw, cut fruit segments in the flavoring agent; soaking the raw, cut fruit segments in the flavoring agent; or injecting the flavoring agent into the raw, cut fruit segments. In one particular embodiment, the flavoring agent is diluted prior to use. In another particular embodiment, the flavoring agent is directly contacted with the cut fruit segments.

In one particular embodiment, the flavoring agent penetrates the entire fruit segment. In another embodiment, the flavoring agent penetrates less than the entire fruit segment.

In at least one embodiment, the fruit to be flavored is immersed or soaked in a liquid slurry. The liquid slurry may comprise one or more of the following: water, an anti-browning agent, a flavoring agent, a sweetener. In at least one embodiment, the liquid slurry comprises approximately 0-99% water. In at least one embodiment, the liquid slurry comprises approximately 10-90% water. In at least one embodiment, the liquid slurry comprises less than 1% water, at least 1% water, 5% water, 10% water, 15% water, 20% water, 30% water, 40% water, 50% water, 60% water, 70% water, 80% water, 85% water, 90% water, 95% water, or any value therebetween or greater. In one embodiment, the liquid slurry comprises 85.8% water. In one embodiment, the liquid slurry comprises 86.8% water.

In at least one embodiment, the liquid slurry comprises approximately 0-15% anti-browning agent. In at least one embodiment, the liquid slurry comprises less than 1%, 1%, 2%, 3%, 4%, 5%, 6%, 7%, 8%, 9%, 10%, 12%, 14%, 15% anti-browning agent or any value therebetween or greater. In one embodiment, the liquid slurry comprises 8.2% anti-browning agent. In one embodiment, the anti-browning agent is NatureSeal™, as described previously herein. In one embodiment, the liquid slurry comprises 8.2% NatureSeal™. In one embodiment, the liquid slurry comprises Freshxtend™, as described previously herein. In one embodiment, the liquid slurry comprises 8.2% Freshxtend™.

In at least one embodiment, the liquid slurry comprises approximately 0-10% sweetener. In at least one embodiment, the liquid slurry comprises less than 1%, 1%, 2%, 3%, 4%, 5%, 6%, 7%, 8%, 9%, 10% sweetener or any value therebetween or greater. In one embodiment, the sweetener is Shugr™, as described previously herein. In one embodiment, the liquid slurry comprises 1% Shugr™. In one embodiment, the liquid slurry comprises 1.5% Shugr™. In one embodiment, the liquid slurry comprises 2% Shugr™.

In at least one embodiment, the liquid slurry comprises approximately 0-100% flavoring agent. In one embodiment, the liquid slurry comprises less than 1%, 1%, 2%, 3%, 4%, 5%, 6%, 7%, 8%, 9%, 10%, 20%, 30%, 40%, 50%, 60%, 70%, 80%, 90%, 100%, or any value therebetween. Any flavoring agent, whether or not described herein, may be used in the liquid slurry. In certain embodiments, the flavoring agent and the anti-browning agent may be the same chemical. In certain embodiments, the flavoring agent and the sweetener may be the same chemical. In certain embodiments, the anti-browning agent and the sweetener may be the same chemical. In at least one embodiment, the flavoring agent includes one or more of the following: Natural Strawberry Flavor, Natural Alphonso Mango Type Flavor, Natural Kiwi Type Flavor, Natural English Toffee Flavor, Natural Maple Type Flavor, Natural Caramel Type Flavor, Natural Apple Pie Flavor, Natural Maple Type Flavor, Natural Raspberry Flavor, Natural Cola Flavor, Tropical Flavors, wild berry, Natural Peach Type Flavor, Natural Coconut type Flavor, Natural Bubble Gum Type Flavor, Natural Passion Fruit Type Flavor, Natural Wildberry Type Flavor, Natural Apple Pie Type Flavor, Natural Orange Cream Flavor, Natural Pina Colada Flavor, Natural Sweet Cherry Flavor, any buttery versions of these, any versions with cinnamon added, or others.

Timing for Flavoring

One embodiment of the present invention further relates to a method for flavoring raw fruit, comprising cutting said fruit into segments and contacting said segments with a liquid bath, spray, immersion, or other delivery means comprising one or more flavoring agents and/or one or more anti-browning agents. In some embodiments, the flavoring and anti-browning agent may be the same chemical. In one particular embodiment, the time the raw, cut or uncut fruit segments or fruit are in contact with one or more flavoring agents is in the range of about 1 second to about 35 days. In another particular embodiment, the time the raw, cut or uncut fruit segments or fruit are in contact with one or more flavoring agents is in the range of about 1 day to about 35 days. In another particular embodiment, the time the raw, cut or uncut fruit segments or fruit are in contact with one or more flavoring agents is in the range of about 7 days, about 14 days, about 21 days, about 28 days or any value therebetween. In another particular embodiment, the time the raw, cut or uncut fruit segments or fruit are in contact with one or more flavoring agents is in the range of about 10 seconds to about 24 hours. In another particular embodiment, the time the raw, cut or uncut fruit segments or fruit are in contact with one or more flavoring agent(s) is in the range of about 1.5 to about 8 minutes. In another embodiment, the time the raw cut or uncut fruit segments or fruit are in contact with one or more flavoring agents is in the range of about 1 minute to about 30 minutes. In another embodiment, the time the raw cut or uncut fruit segments or fruit are in contact with one or more flavoring agents is in the range of about 1 minute to about 20 minutes. In another embodiment, the time the raw cut or uncut fruit segments or fruit are in contact with one or more flavoring agents is in the range of about 1 minute to about 15 minutes. In another embodiment, the time the raw cut or uncut fruit segments or fruit are in contact with one or more flavoring agents is in the range of about 1 minute to about 20 minutes. In another particular embodiment the time the raw, cut or uncut fruit segments are in contact with one or more flavoring agents is in the range of about 2.5 to about 5.0 minutes. In one embodiment, the time the raw, cut fruit segments are in contact with one or more flavoring agents is about 2.0 minutes, about 2.5 minutes, about 3.0 minutes, about 3.5 minutes, about 4.0 minutes, about 4.5 minutes, about 5.0 minutes, or any time therebetween.

Timing for Cutting and Flavoring

At least one embodiment of the presently claimed invention also relates to a method for flavoring raw fruit, comprising cutting said fruit into segments, and contacting said fruit segments with one or more flavoring agents, wherein said fruit segments are exposed to air for 24 hours or less prior to contacting said flavoring agents. In one embodiment, the cut fruit segments are exposed to air for 30 minutes or less prior to contacting said flavoring agents. In one embodiment, the cut fruit segments are exposed to air for 15 minutes or less prior to contacting said flavoring agents. In one embodiment, the cut fruit segments are exposed to air for 10 minutes or less prior to contacting said flavoring agents. In one embodiment, the cut fruit segments are exposed to air for 5 minutes or less prior to contacting said flavoring agents. In one embodiment, the cut fruit segments are exposed to air for 3 minutes or less prior to contacting said flavoring agents. In one embodiment, the cut fruit segments are exposed to air for 2 minutes or less prior to contacting said flavoring agents. In one embodiment, the cut fruit segments are exposed to air for 1 minute or less prior to contacting one or more flavoring agents. In one particular embodiment, the raw, cut fruit segments are exposed to air for 30 seconds or less prior to contacting one or more flavoring agents. In another particular embodiment, the raw, cut fruit segments are exposed to air for 10 seconds or less prior to contacting one or more flavoring agents. In another particular embodiment, the raw, cut fruit segments are exposed to air for 1 second or less prior to contact with one or more flavoring agents. In another particular embodiment, the raw, cut fruit segments are exposed to air for between 3-5 seconds prior to contact with one or more flavoring agents. In another particular embodiment, the raw, cut fruit segments are exposed to air for between 1-60 seconds prior to contact with one or more flavoring agents.

At least one embodiment of the present invention also relates to a method for flavoring raw fruit, comprising cleaning said fruit, possibly cutting said fruit into segments, contacting said fruit or fruit segments with one or more flavoring agents and/or one or more anti-browning agents, reducing or eliminating excess moisture, flavoring agents or anti-browning agents and packaging said fruit or fruit segments. Excess moisture in the flavored fruit or fruit segments may comprise water, juices, or any other liquid or liquid solution containing dissolved nutrients or other agents.

At least one embodiment of the present invention relates to compositions and methods of flavoring raw, cut or uncut fruit segments or fruit further comprising packaging the raw, cut or uncut, flavored fruit segments or fruit into a container. In one embodiment, the raw, cut or uncut, flavored fruit segments or fruit are packaged simultaneously with, or subsequent to contacting with one or more flavoring agents. In another embodiment, the raw, cut or uncut fruit segments or fruit are contacted with one or more anti-browning agents prior to or simultaneously with packaging. In another embodiment, the raw, cut or uncut fruit segments or fruit are contacted with one or more anti-browning agent(s) prior to, simultaneously with, or subsequent to contacting with one or more flavoring agent(s). In another embodiment, the raw, cut or uncut fruit segments or fruit are contacted with one or more flavoring agent(s) prior to, simultaneously with, or subsequent to contact with one or more anti-browning agent(s). In another embodiment, the raw, cut or uncut fruit segments or fruit are contacted with one or more flavoring agents prior to, simultaneously with, or subsequent to packaging.

One of skill in the art would readily appreciate the presently claimed invention may be practiced by using a variety of packaging containers and materials. Such packaging materials may include polystyrene, polypropylene, cellophane, or any combination thereof. One of skill in the art would recognize that any of the described containers may be resealable, and/or reusable.

Examples of containers that may be used with the present invention include a clamshell container, such as Clamcell™, plastic cup, tub, box or a bag. Examples of a bag that may be used with the present invention include a porous or mesh bag; plastic bag; poleolefin bag; polyethylene bag, such as Poly Bag™; a bag that regulates gas content or exchange, which include the Keep Crisp™ bag that regulates oxygen content, and the Bio-Fresh® bag that absorbs gases such as ethylene, ammonia and/or hydrogen sulfide, or any combination thereof. Any packaging that regulates gas content or exchange may retard the ripening and/or decaying process and thus, may be used with the present invention.

One of skill in the art would recognize that such bag or other container may be resealable or have a zipper-type seal. Further, such bag or other container may have a pull-tab for ease in opening. Examples of a box that may be used with the present invention include waxed cardboard or plastic box, and include a gift box. In one embodiment, the container is a tub, such as a plastic tub. One of skill in the art would recognize such tub may be resealable and/or reusable.

One of skill in the art would readily appreciate that any container utilized in the presently claimed invention may comprise one or more sectioned chambers. Such sectioned chambers may each hold different or the same kinds of raw, cut fruit segments. In addition, such sectioned chambers may each hold raw, cut fruit segments that have contacted different or the same flavoring agents and/or anti-browning agents. Such one or more sectioned chambers may include one or more internal containers. For example, the container may contain a bag within a bag or a box within a box or any combination thereof. In one embodiment, the one or more sectioned chambers have solid walls or porous walls. In a further embodiment, the porous walls of the sectioned chambers act as a sieve to separate solid raw, cut fruit segments from any liquid fruit juices and/or flavoring agents and/or anti-browning agents.

Packaging and Storing

At least one embodiment of the present invention also relates to a method for flavoring raw fruit, comprising cutting said raw fruit into segments, contacting said segments with one or more flavoring agents and packaging said raw, cut, flavored fruit segments. In one embodiment, the fruit segments are vacuum packed in a container. In the same or a different embodiment, the raw, cut fruit segments are packaged in a modified or controlled atmosphere container. Such modified or controlled atmosphere may comprise elevated carbon dioxide levels, elevated nitrogen levels, reduced oxygen levels, reduced ethylene levels, or any combination thereof. In another particular embodiment, the container is pre-treated with fungicide or other pesticide. In another exemplary embodiment, the container is pre-treated with a chemical that reduces or eliminates mold, mildew, or rot.

The present invention also relates to storing the raw, cut, flavored fruit segments prior to or subsequent to packaging. In one particular embodiment, the raw, cut fruit segments are stored prior to packaging. In another particular embodiment, the raw, cut fruit segments are stored subsequent to packaging.

The present invention also relates to storing the uncut fruit prior to cutting and/or contacting with one or more flavoring agent and/or one or more anti-browning agent. In one embodiment, the uncut fruit is stored in an environment with a temperature range of 30-80° F. prior to cutting and contacting with one or more flavoring agents. In another particular embodiment, the uncut fruit is stored in an environment with a temperature range of 30-53° F. In another embodiment, the uncut fruit is stored in an environment with a relative humidity range of 85-95%.

At least one embodiment of the present invention includes cutting and contacting the fruit with one or more flavoring agents in an environment whose temperature range is 30-80° F. In one embodiment, the fruit is contacted with one or more flavoring agents in an environment whose temperature range is 50-60° F.

At least one embodiment of the present invention relates to storing the raw, cut fruit segments prior to or subsequent to packaging, in an environment with a temperature range of 33-80° F. In one particular embodiment, the raw, cut fruit segments are stored prior to or subsequent to packaging, in an environment with a temperature range of 50-60° F. In another particular embodiment, the raw, cut fruit segments are stored prior to packaging, in an environment with a temperature range of 33-80° F. In another particular embodiment, the raw, cut fruit segments are stored prior to packaging, in an environment with a temperature range of 50-60° F. In another embodiment, the raw, cut fruit segments are stored subsequent to packaging, in an environment with a temperature range of 50-60° F. In another embodiment, the raw, cut fruit segments are stored prior to packaging, in an environment with a temperature range of 33-35° F. In another embodiment, the raw, cut fruit segments are stored subsequent to packaging, in an environment with a temperature range of 33-35° F.

At least one embodiment includes compositions comprising raw, cut or uncut, flavored fruit segments or fruit that have a shelf-life of up to 14 days, 21 days, 30 days, 40 days, or any number therebetween or greater. One embodiment of the presently claimed invention includes harvesting, cutting, flavoring and packaging the fruit all within 1 to 7 days. One embodiment of the presently claimed invention includes harvesting, possibly cutting, flavoring and packaging the fruit all within one month to one year.

Kits

The present invention also relates to a kit for flavoring raw fruit segments comprising one or more packaged flavoring agent(s) for raw, cut or uncut fruit segments or fruit. In one embodiment, the kit further comprises one or more anti-browning agent(s). In the same or a different embodiment, the kit further comprises cut or uncut, raw fruit segments or fruit. In one particular embodiment, the cut or uncut, raw fruit segments or fruit have been contacted with one or more anti-browning agent. The form and substance of the flavoring agent(s) and anti-browning agent(s) in the claimed kit of the present invention include those of any other embodiment described herein. Likewise, the modes of applying the flavoring agent(s) and/or anti-browning agent(s) include those described herein for other embodiments. The kind or variety of fruit in the kit of the present invention includes that of any of the embodiments described herein.

The kit described herein may further comprise instructions as to how to use said packaged flavoring for said raw, cut or uncut fruit segments or fruit. Instructions may include how long to contact said raw, cut or uncut fruit segments or fruit with said packaged flavoring agent and/or said anti-browning agent. Instructions may also include how to cut said raw fruit segments, use said packaged flavoring agent for flavoring said raw, cut or uncut fruit segments or fruit and/or use said packaged anti-browning agent for said raw cut or uncut fruit segments or fruit.

The present invention further relates to assessing the fruit for quality prior to packaging in the kit. Such assessment includes that which is described herein for other embodiments of the claimed invention.

The present invention may further include one or more natural, artificial or organic color in the claimed kit. Such natural, artificial or organic color is known in the art, and is also described herein for other embodiments. The invention may further include one or more natural, artificial or organic sweetener in the claimed kit. Such sweeteners are known in the art, and are also described herein for other embodiments. The invention further may include one or more natural or artificial flavor enhancer. Such flavor enhancers are known in the art, and are also described herein for other embodiments.

In one embodiment, the presently claimed kit further comprises a brush. In at least one embodiment, the kit comprises a handheld spray pump. In at least one embodiment, the kit further comprises a cutting device. Such cutting device may be made of plastic. In one embodiment, the cutting device is a wedge tool or knife. In another embodiment, the cutting device is a slicer and/or corer. In another embodiment, the cutting device produces a recognizable shape, such as a form, figure, word, cartoon character, animal, logo, symbol, or the like. In one embodiment, the presently claimed kit further comprises an impression tool. Such impression tool may be similar to a cookie cutter that leaves an image impressed on the fruit segment and/or cuts the fruit segment into a particular shape.

In one embodiment, the presently claimed kit comprises a fruit handling device. Such fruit handling device may be tongs or a fork. Such fruit handling device may be made of plastic. In one embodiment, the presently claimed kit comprises a container.

In addition to the techniques or modes of contacting raw, cut or uncut fruit segments or fruit with one or more flavoring agent(s) and/or one or more anti-browning agent(s), the present invention may further include contacting a gaseous flavoring agent and/or anti-browning agent via a swab that has been impregnated with the flavoring and/or anti-browning agent. It is understood that all of the anti-browning and/or flavoring agent(s) described herein may be applied directly to the raw, cut or uncut fruit segments or fruit, or diluted prior to use.

System

At least one embodiment of the present invention also relates to an automated system for flavoring raw fruit, comprising transporting the fruit by conveyor belt or any other delivery means to one or more flavoring agents. In at least one embodiment, the fruit is first transported to a cutting device, where the fruit is cut into segments, and contacted with one or more flavoring agents. In one particular embodiment, the system further comprises packaging the raw, cut or uncut, flavored fruit segments or fruit. In another particular embodiment, the system further comprises unloading the fruit from a truck, dock or other carrier. In another particular embodiment, the system further comprises transporting the fruit from an orchard, greenhouse or other growing facility to the cutting device. In one particular embodiment, the system is regulated, operated or controlled by a computer system. In one particular embodiment, at least part of the computer system is remote from the rest of the automated fruit flavoring system. In another particular embodiment, information contained on or in the fruit may be entered into the computer and used for tracking the fruit through the flavoring and/or packaging process.

The types and varieties of fruit that may be used to practice this particular aspect of the invention include all types and varieties described herein, as well as others known in the art. Likewise, one of skill in the art would recognize the form and substance of a flavoring agent and/or anti-browning agent; as well as methods of application; time ranges from cutting to contact; time range in contact with such agents; removal of excess moisture, flavoring agent and/or anti-browning agent; packaging and/or storing of the fruit may vary according to the desired flavored fruit segment outcome. Various examples of all of these variations in methods are described herein and apply to this particular aspect of the claimed invention as well.

In one embodiment, the system further comprises the step of assessing the fruit for quality prior to flavoring. Such assessment has been described herein with regard to practicing other embodiments and likewise applies to this particular aspect as well.

Business Methods

At least one embodiment of the present invention further relates to a business method comprising possibly cutting raw fruit into segments, contacting said fruit segments or uncut fruit with one or more flavoring agents, packaging said segments or fruit and selling said raw, cut or uncut, flavored fruit segments or fruit. In a further embodiment, the business method comprises the step of storing said fruit after harvest and prior to cutting said raw fruit into segments and/or flavoring the fruit.

In another particular embodiment, the invention comprises the step of a company licensing rights from another organization to market or sell the raw, cut or uncut, flavored fruit segments or fruit. In another particular embodiment, the step of marketing or selling the fruit comprises an organization collecting royalties from a company that sells the raw, cut or uncut, flavored fruit segments or fruit. The invention further comprises the step of storing the tracked fruit after harvest and prior to possibly cutting the raw fruit into segments. In another particular embodiment, the invention further comprises the step of collecting fees from a company that sells the raw, cut or uncut, flavored fruit segments or fruit. In one particular embodiment, the fees comprise at least one of license fees or milestone fees.

In another particular embodiment, a company licenses or acquires the rights to market or sell the raw, cut or uncut, flavored fruit segments or fruit and the company identifies another flavoring formulation. In one particular embodiment, the flavoring formulation is a marketed flavoring. In another particular embodiment, the flavoring formulation is off patent.

The present invention further comprises the step of patenting the newly-identified flavoring formulation or method of using the flavoring formulation for the raw, cut, or uncut flavored fruit segments or fruit.

In any of the aforementioned business methods, the company may be a wholesale or retail grocery, a franchise chain, a theme park, a restaurant, a fast food restaurant, a food processing or manufacturing plant, or any combination thereof. In any of the aforementioned business methods, the organization may be a packer owned orchard, a privately held orchard, a fruit cooperative, or any combination thereof. In any one of the aforementioned business methods, the fruit may be derived from one single fruit grower, or the fruit may be derived from multiple fruit growers. In any one of the aforementioned business methods, the raw, cut or uncut, flavored fruit segments or fruit may be exported from the United States.

The present invention further relates to business methods comprising the step of storing the raw, cut or uncut fruit segments or fruit prior to or subsequent to packaging. The present invention further relates to business methods comprising storing the uncut fruit prior to cutting and/or contacting with at least one flavoring and/or at least one anti-browning agent.

The present invention also relates to a business method comprising tracking the fruit through the cutting, flavoring and/or packaging process. In another embodiment, the business method further comprises tracking the fruit from an orchard, greenhouse or other growing facility, through the cutting, flavoring and/or packaging process. In another embodiment, the business method comprises tracking the fruit through transporting and up to and including delivery to the wholesale or retail seller. In another particular embodiment, the invention comprises tracking the fruit up to and including consumer purchase. Such method may include the use of a computer to enter, store, access and retrieve information regarding the status of the fruit or status of the cutting, flavoring, packaging, and/or transporting process. Such a computer used for tracking fruit or the origin of the fruit, may be operated by a remote user, such as a human being, another computer or robot.

In another particular embodiment, the invention comprises the step of a company licensing rights from another organization to market or sell the raw, cut or uncut, flavored fruit segments or fruit. In another particular embodiment, the step of marketing or selling the fruit comprises an organization collecting royalties from a company that sells the raw, cut or uncut, flavored fruit segments or fruit. The invention further comprises the step of storing the tracked fruit after harvest and prior to cutting the raw fruit into segments. In another particular embodiment, the invention further comprises the step of collecting fees from a company that sells the raw, cut or uncut, flavored fruit segments or fruit. In one particular embodiment, the fees comprise at least one of license fees or milestone fees.

In another particular embodiment, a company licenses or acquires the rights to market or sell the raw, cut or uncut, flavored fruit segments or fruit and the company identifies another flavoring formulation. In one particular embodiment, the flavoring formulation is a marketed flavoring. In another particular embodiment, the flavoring formulation is off patent.

The present invention further comprises the step of patenting the newly-identified flavoring formulation or method of using the flavoring formulation for the raw, cut or uncut, flavored fruit segments or fruit.

In any of the aforementioned business methods, the company may be a wholesale or retail grocery, a franchise chain, a theme park, a restaurant, a fast food restaurant, a food processing or manufacturing plant, or any combination thereof. In any of the aforementioned business methods, the organization may be a packer owned orchard, a privately held orchard, a fruit cooperative, or any combination thereof. In any one of the aforementioned business methods, the fruit may be derived from one single fruit grower, or the fruit may be derived from multiple fruit growers. In any one of the aforementioned business methods, the raw, cut or uncut, flavored fruit segments or fruit may be exported from the United States.

The present invention further relates to business methods comprising the step of storing the raw, cut or uncut fruit segments prior to or subsequent to packaging. The present invention further relates to business methods comprising storing the uncut fruit prior to cutting and/or contacting with at least one flavoring and/or at least one anti-browning agent.

One of skill in the art would recognize that a variety of types of tracking devices might be employed with practicing the presently claimed invention. In particular, radio frequency tags, bar codes or other identifying marks or information may be used to track fruit from the orchard, greenhouse or other growing facility all the way up to and including the consumer purchase. Such identifying marks or information may be physically contained on the fruit itself, contained on the tree, branch, or other growing receptacle where the fruit originated, and may be transferred to a packaging label or entered into a computer tracking system. Identifying marks may include a chemical or color tattoo, a laser etching, a burn mark or brand, or other color mark, a sticker or label, or other informational tag.

Process for Manufacture

At least one aspect of the present invention also relates to a process for manufacturing raw, cut or uncut, flavored fruit segments or fruit comprising possibly cutting said fruit into segments, contacting said segments or uncut fruit with one or more flavoring agents and packaging said segments or fruit, thereby manufacturing said raw, cut or uncut, flavored fruit segments or fruit. For purposes of practicing this particular aspect of the presently claimed invention, the fruit is selected from the group consisting of apples, pears, Asian pears, cherries, any other fruit disclosed herein and any combination thereof. The particular aspects described herein for all other embodiments may likewise be applied to this particular aspect of the invention.

The following examples are offered by way of illustration and not by way of limitation of the invention. It is understood that the examples and embodiments described herein are for illustrative purposes only and that various modifications or changes in light thereof will be suggested to persons skilled in the art and to be included within the scope and spirit of the invention.

### WORKING EXAMPLES

### Example 1

### Flavored Fruit Segments

Cameo and Golden Delicious apples were used in this example. Cameo apples have a red skin and may be more acidic and less sweet than other apples. Golden Delicious apples may be yellow in color and sweeter, or green in color with more green notes, and not as sweet.

Liquid Slurry

A liquid slurry was made for flavoring the fruit. The slurry included Nature Seal™ (an antioxidant, preservative and mineral provider), 5×Shugr™, and flavorings, in liquid. The flavors were tested at 4.0% slurry for the following flavorings: Natural Maple Type Flavor, Natural Apple Pie Flavor, Natural Caramel Type Flavor, Natural Raspberry Flavor, Natural Caramel Type Flavor, Natural Cola Type Flavor. The flavorings are natural, water-soluble (diluted with ethyl alcohol and glycerine).

Cutting the Fruit

Apples were cut to create 12 apple slices.

Flavoring the Fruit

The fresh cut apple slices were soaked in the liquid slurry for two minutes, thirty seconds, then dried (by shaking off excess liquid), bagged and refrigerated. Apple slices were tasted later the same day, one day later, one week later, and 3 weeks later, to ensure flavor longevity. Some flavorings (for example, Raspberry and Cola) benefited from the acid levels in the fruit slurry).

### Example 2

### Flavored Fruit Segments

Cameo, Red Delicious, Gala, Golden Delicious and Fuji apples were used in this example. Cameo apples may have a deep, red skin and be acidic, less sweet and have a firm texture. Red Delicious apples may have a red, shiny skin, a firm texture, be quite acidic, and have some sweetness. Gala apples may have a light reddish-orange color, have a firm texture, be slightly acidic, and have more sweetness. Many people prefer Gala apples due to its great taste and natural flavor. Golden Delicious apples may be yellow in color, have a softer texture, may be less acidic, and may be very sweet. Fuji apples may be red and green in color, have soft texture, very little to no acidity, little to no sweetness, generally less flavor, and may be less preferred unless flavored.

Liquid Slurry

A liquid slurry was made according to the following formula: 85.8% water, 8.2% Nature Seal™, 2.0% 5×Shugr™, 4.0% Flavor. (10× Shugr™ can be used at 1% in place of the 5× Shugr™ at 2.0%). The flavors were natural and water-soluble. The flavorings used in this example include Natural Strawberry Flavor, Natural Alphonso Mango Type Flavor, Natural Kiwi Type Flavor, Natural English Toffee Flavor, Natural Maple Type Flavor, Natural Caramel Type Flavor and Natural Apple Pie Flavor.

Cutting the Fruit

Apples were sliced and then each slice was manually cut again to create very thin slices. Slices tested were thinner than in Example 1.

Flavoring the Fruit

Apple slices were introduced to the liquid slurry as noted above for 4.0 minutes by soaking. After 4 minutes, the slices were removed from the slurry, shaken dry, placed in sealed plastic bags and refrigerated. The slices were then tested within 24 hours, after one week and after 3 weeks to ensure flavor longevity.

### Example 3

### Flavored Fruit Segments

Golden delicious and Gala apples were used for this example.

Liquid Slurry

The liquid slurry to flavor the fruit was made according to the following formula: water at 85.8%, Fresh Xtend™ or Nature Seal™ at 8.2%, 5×Shugr™ at 2.0%, Flavor at 4.0%. (10× Shugr™ can be substituted for the 5× Shugr™, at half the concentration). The same formula was also tested with 10× Shugr™ at 2.0%. The following flavors were included: Tropical Flavors, Natural Peach Type Flavor, Natural Coconut Type Flavor, Natural Bubble Gum Type Flavor, Natural Passion fruit Type Flavor, Natural Wildberry Type Flavor, Natural Apple Pie Type Flavor (buttery version), Natural Caramel Type Flavor (buttery version), Natural Maple Type Flavor (buttery version).

Cutting the Fruit

The fruit was cut into slices, and the slices were cut again manually to create 12 slices.

Flavoring the Fruit

The apple slices were dipped, then tasted and evaluated.

In addition to 5× Shugr™ being tested at 2.0%, 10×Shugr™ was tested at 2.0% using Golden Delicious apples with Natural Caramel Type Flavor. Each apple was tested and evaluated. The apples tested with 10× Shugr™ were extremely sweet with a slightly bitter taste.

### Example 4

### Flavored Fruit Segments

Golden Delicious and Gala apples were used for this example. The Golden Delicious apples were greener and less ripe than the previously tested apples. The Gala apples were riper, mushy and not as sweet and flavorful as apples previously tested.

Liquid Slurry

A liquid slurry was made according to the following formula: water at 86.8%, Fresh Xtend™ at 8.2%, 10×Shugr™ at 1.0%, and Flavor at 4.0%. (Flavors may also be used in powder form). All flavorings w ere natural and water soluble. Flavorings used were Natural Orange Cream Flavor, Natural Pina Colada Flavor, Natural Apple Pie Flavor, Natural Sweet Cherry Flavor, Natural Apple Pie Flavor (with more cinnamon), Natural Wildberry Flavor.

In addition to 5× Shugr™ being tested at 2.0%, 10×Shugr™was tested at 1.5% with Natural Wildberry Type Flavor (4.0%). The apple slices were tested and evaluated.

Cutting the Fruit

Some apples were cut using a 12 section press down slicer. Some apples were cut using an automated slicer (the slices were then cut again manually to create 12 slices).

Flavoring the Fruit

The apple slices were soaked in the liquid slurry, then tasted and evaluated.

### Example 5

Cutting the Fruit

Whole apples were sliced into 12 pieces.

Flavoring the Fruit

The sliced fruit pieces were aligned onto a flavor tunnel conveyor system and transported through the system as the fruit pieces were flavored on both sides by turning the pieces. Powdered flavoring agents were applied at about 1% concentration by a rotary dispersal unit with a variable frequency drive motor to control the speed that the fruit pieces are conveyed under the flavor applicator to ensure even distribution of flavoring agents.

### Example 6

Cutting the Fruit

Whole apples were sliced into 12 pieces.

Flavoring the Fruit

The sliced apples were aligned onto a flavor tunnel conveyor system and transported through the system as the fruit pieces were flavored on both sides by turning the pieces. Powdered flavoring agents were added at a rate of about 1% by an electrostatic application unit that atomized the flavoring agents and relatively evenly projected them onto the sliced fruit pieces.

### Example 7 (Prophetic Example)

Any type of fruit disclosed herein may be used in this Example. The fruit will be cored and/or cut and dusted with one or more flavoring agent(s) as well as one or more sweetener(s). The flavoring agent and sweetener may be blended for ease of use, or used separately. The fruit will be temporarily stored, then tasted and evaluated.

1. A method for flavoring raw fruit, comprising contacting said fruit with a first compound comprising one or more flavoring agents and a second compound comprising one or more anti-browning agents.

2. The method of claim 1, wherein said fruit is selected from the group consisting of apples, pears, Asian pears, cherries, and any combination thereof.

3. The method of claim 1, further comprising the step of cutting said fruit prior to, simultaneously with or subsequent to contacting with said first compound and said second compound.

4. The method of claim 1, further comprising the step of assessing said fruit for quality prior to contacting with one or more flavoring agents.

5. The method of claim 4, wherein the step of assessing said fruit for quality is based on one or more fruit grade assessments selected from the group consisting of: measuring sugar content or testing soluble solids, measuring whole fruit size, measuring starch content, measuring fruit firmness or pressure, testing fruit acidity, assessing fruit color, assessing seed color, assessing fruit taste, assessing fruit texture and assessing fruit aroma.

6. The method of claim 1, further comprising cleaning the fruit prior to cutting into segments.

7. The method of claim 1, wherein said fruit segments are selected from the group consisting of slices, rings, chunks, wedges, quarters, halves and any combination thereof.

8. The method of claim 1, wherein said fruit segments are contacted with one or more anti-browning agents prior to, simultaneously with, or subsequent to contacting with one or more flavoring agents.

9. The method of claim 1, wherein said one or more flavoring agent(s) is selected from the group consisting of: apple, chocolate, rum, triple sec, peppermint, ginger, orange, lemon, lime, blueberry, blackberry, strawberry, margarita, pina colada, daiquiri, cherry, root beer, butterscotch, peanut butter, vodka, gin, whiskey, brandy, cheese, merlot wine, cabernet wine, chardonnay wine, smoked, barbeque, chipotle, ranch, curry, vanilla, mint, cinnamon, apple pie, raspberry, maple, grape, cola, caramel, mango, kiwi, English Toffee, cocoa, tropical flavors, bubble gum, peach, coconut, bergamot, cinnamon bark, ginger ale, grapefruit, lemon-lime, mandarin, sweet orange, triple sec, almond butter, butter pecan, coffee, cream, honey, peanut, guava, amaretto, Asian Blender, Crème de Menthe, Kalamansi, Sloe berry, Chai Tea, Tequila, white strawberry, white cranberry, ginger, white grape, guarana, jasmine, malted milk, mint, orange juice, orange sherbet, Oriental Herbal, punch, sugar, tropical fruit, Chichamorada, Cherimoya, Ginseng mint, melon, papaya, Ming Tea, Sweet Musk melon, pandan, tamarind, tangerine, strawberry kiwi, guanabana, peach apricot, Apple strudel, chocolate cherry, chocolate mint, French vanilla, licorice, minty melon, Amaretto, chocolate fudge, green bell pepper, Muscat, baby powder, Boston Crème, cantaloupe, cheesecake, chocolate hazelnut, cologne, hazelnut, pine oil, pizza, sesame oil, pumpkin spice, rose, brown sugar, sweet roll, tropical punch, vanilla cream, Bleu Cheese, melted butter, sweet butter, roasted chicken, milk chocolate, toasted coconut, ginger snap, graham cracker, mushroom, pecan, pistachio, red raspberry, blue raspberry, strudel, wafer, walnut, Royal cream, sour cream, dry apricot, caramel corn, cotton candy, cranapple, Temple orange, fresh pineapple, black raspberry, fresh strawberry, passion fruit, wildberry, orange cream, sweet cherry, banana, mango, wild raspberry, wild blueberry, wild blackberry, root beer cream, cola cream, carrot, carrot cake, pumpkin, “buttery” versions of any of these flavors, any flavors with cinnamon or extra cinnamon, and any combination thereof.

10. The method of claim 1, wherein said one or more anti-browning agent(s) is selected from the group consisting of: citric acid; NatureSeal™; vitamins, mineral, ascorbic acid; potassium sorbate; enzymes; acids; bases; erythorbic acid; calcium; sulfur dioxide; sulfites; benzoic acid; Freshxtend™, butylated hydroxyanisole (BHA), butylated hydroxytoluene (BHT), tert-butylhydroquinone (TBHQ), propyl gallate, ascorbyl palmitate; and any combination thereof.

11. The method of claim 1, wherein said first compound or said second compound further comprises one or more selected from the group consisting of: natural, artificial, or organic sweetener; natural, artificial, or organic color; and natural, artificial, or organic flavor enhancer.

12. The method of claim 1, wherein said flavoring agent is in a form selected from the group consisting of: solid, liquid, gas, gel, paste, and any combination thereof.

13. The method of claim 1, wherein said raw, cut fruit segments are exposed to air for 10 minutes or less prior to contact with said first compound or said second compound.

14. The method of claim 1, further comprising packaging said flavored fruit segments into a container.

15. The method of claim 1, further comprising storing said raw, cut, flavored fruit segments prior to, simultaneously with, or subsequent to packaging said segments.

16. A composition comprising raw, cut, flavored fruit segments, wherein said fruit segments comprise raw, cut fruit and one or more flavoring agents.

17. The composition of claim 16, wherein said one or more flavoring agents is selected from the group consisting of: apple, chocolate, rum, triple sec, peppermint, ginger, orange, lemon, lime, blueberry, blackberry, strawberry, margarita, pina colada, daiquiri, cherry, root beer, butterscotch, peanut butter, vodka, gin, whiskey, brandy, cheese, merlot wine, cabernet wine, chardonnay wine, smoked, barbeque, chipotle, ranch, curry, vanilla, mint, cinnamon, apple pie, raspberry, maple, grape, cola, caramel, mango, kiwi, English Toffee, cocoa, tropical flavors, bubble gum, peach, coconut, bergamot, cinnamon bark, ginger ale, grapefruit, lemon-lime, mandarin, sweet orange, triple sec, almond butter, butter pecan, coffee, cream, honey, peanut, guava, amaretto, Asian Blender, Crème de Menthe, Kalamansi, Sloe berry, Chai Tea, Tequila, white strawberry, white cranberry, ginger, white grape, guarana, jasmine, malted milk, mint, orange juice, orange sherbet, Oriental Herbal, punch, sugar, tropical fruit, Chichamorada, Cherimoya, Ginseng mint, melon, papaya, Ming Tea, Sweet Musk melon, pandan, tamarind, tangerine, strawberry kiwi, guanabana, peach apricot, Apple strudel, chocolate cherry, chocolate mint, French vanilla, licorice, minty melon, Amaretto, chocolate fudge, green bell pepper, Muscat, baby powder, Boston Crème, cantaloupe, cheesecake, chocolate hazelnut, cologne, hazelnut, pine oil, pizza, sesame oil, pumpkin spice, rose, brown sugar, sweet roll, tropical punch, vanilla cream, Bleu Cheese, melted butter, sweet butter, roasted chicken, milk chocolate, toasted coconut, ginger snap, graham cracker, mushroom, pecan, pistachio, red raspberry, blue raspberry, strudel, wafer, walnut, Royal cream, sour cream, dry apricot, caramel corn, cotton candy, cranapple, Temple orange, fresh pineapple, black raspberry, fresh strawberry, passion fruit, wildberry, orange cream, sweet cherry, banana, mango, wild raspberry, wild blueberry, wild blackberry, root beer cream, cola cream, carrot, carrot cake, pumpkin, “buttery” versions of any of these flavors, any flavors with cinnamon or extra cinnamon, and any combination thereof.

18. The composition of claim 16, wherein said fruit segments further comprise one or more anti-browning agents.

19. The composition of claim 16 wherein said fruit is selected from the group consisting of apples, pears, Asian pears, cherries and any combination thereof.

20. A kit for flavoring raw fruit segments, comprising one or more packaged flavoring agents for raw, cut fruit segments.

21. The kit of claim 20, further comprising one or more packaged anti-browning agents.

22. An automated system for flavoring raw fruit, comprising transporting said fruit by conveyor belt to a cutting device, cutting said fruit into segments with said cutting device and flavoring said fruit segments.

23. A business method comprising cutting raw fruit into segments, flavoring said segments, packaging said segments and selling said raw, cut, flavored fruit segments.

24. The method of claim 23, further comprising tracking fruit through the cutting, flavoring and packaging process.
